(19) United States
(12) Patent Application Publication
(10) Pub. No.: US 2011/0060433 A1
(43) Pub. Date: Mar. 10, 2011

(54) BILINEAR ALGORITHMS AND VLSI IMPLEMENTATIONS OF FORWARD AND INVERSE MDCT WITH APPLICATIONS TO MP3 AUDIO

(75) Inventors: Xingdong Dai, Whitehall, PA (US); Meghanad Wagh, Bethlehem, PA (US)

(73) Assignee: LEHIGH UNIVERSITY, Bethlehem, PA (US)

(21) Appl. No.: 12/865,831

(22) PCT Filed: Feb. 2, 2009
(86) PCT No.: PCT/US09/32864

§ 371 Date: Nov. 24, 2010

Related U.S. Application Data
(60) Provisional application No. 61/025,483, filed on Feb. 1, 2008.

(51) Int. Cl. G06F 17/00

(52) U.S. Cl. 700/94

(57) ABSTRACT

Provided herein are hardware efficient bilinear algorithms and methods to compute MDCT/IMDCT of 2̂n and 4.3̂n points. The algorithms and methods for composite lengths have practical applications in MP3 audio encoding and decoding. The MDT/IMDCT can be converted to type-IV discrete cosine transforms (DCT-IV). Using group theory, the methods decomposes DCT-IV transform kernel matrix into groups of cyclic and Hankel product matrices. Bilinear algorithms are then applied to efficiently evaluate these groups. When implemented in VLSI, bilinear algorithms have improved the critical path delays over existing solutions. For MPEG-1/2 layer III (MP3) audio, proposed herein are several different versions of unified hardware architectures for both the short and long blocks and the forward and inverse transforms.

### CROSS-REFERENCE TO RELATED APPLICATIONS

This application claims the priority of application No. 61/025,483 filed Feb. 1, 2008, the entire contents of which are incorporated herein by reference.

### FIELD

Bilinear algorithms and VLSI implementations of forward and inverse MDCT and application thereof to audio encoding and decoding, for example in MPEG 1/2 layer III (also referred to as “MP3”).

### BACKGROUND

Forward and inverse modified discrete cosine transforms (also referred to herein as “MDCT” and “IMDCT”) are widely used for subband coding in the analysis and synthesis filterbanks of time domain alisasing cancellation (also referred to as “TDAC”). Many international audio coding standards rely heavily on fast algorithms for the MDCT/IMDCT.

### BRIEF DESCRIPTION

Methods and applications are provided for hardware efficient bilinear algorithms to compute MDCT/IMDCT of 4×3ⁿ points. The algorithms for composite lengths have practical application in MPEG-1/2 layer III (“MP3” or “mp3”) audio encoding and decoding. The MDCT/IMDCT can be converted to type-IV discrete cosine transform (also referred to herein as “DCT-IV”). Using group theory, the present approach decomposes DCT-IV transform kernel matrix into groups of cyclic, Hankel and/or Toeplix matrices. Bilinear algorithms are then applied to efficiently evaluate these groups. When implemented in very large-scale integration (also referred to as “VLSI”), the bilinear algorithms have improved the critical path delays over other known solutions. This is due to the fact that all sub-groups are computed in parallel and there is only one multiplication along the critical path. In particular embodiments for MP3 audio processing, the inventors provide three different algorithms and VLSI architectures that compute not only the forward and inverse transforms, but also the short and long frames. Definitions herein include: “unified” means encoding as well as decoding, regardless of block size; “accelerator” means any hardware or software device that executes the algorithms described and claimed herein.

By way of non-limiting example, provided herein are embodiments including (1) Bilinear algorithm for 12-point forward and inverse MDCT (MP3 audio short block); (2) Bilinear algorithm for 36-point forward and inverse MDCT (MP3 audio long block); (3) Fast algorithm and unified architecture for MDCT/IMDCT, 1 long block or 1 short block per cycle; (4) Fast algorithm and unified architecture for MDCT/IMDCT, 1 long block or 2 short blocks per cycle; and (5) Pipelined algorithm and unified architecture for MDCT/IMDCT, 0.5 long block and 1 short block per cycle.

These and other embodiments are believed to be the first truly fast and unified algorithms for MP3 audio processing.

### SOME EXEMPLARY EMBODIMENTS

According to an example embodiment hereof, a method for coding and decoding a digital signal in an MPEG format includes the steps of (1) providing at least one digital signal in an MPEG format; and (2) applying an operation to the MPEG signal the operation comprising calculation of a forward modified discrete transform (MDCT) or the inverse modified discrete transform (IMDCT), wherein the applying of the operation results in at least one of 9 or less mutually independent multiplications for a 12-point MDCT or IMDCT, or 36 or less mutually independent multiplications for a 36-point MDCT or IMDCT.

According to the aforementioned method, the operation may provide for generation of at least one transform kernel, decomposition of the transform kernel into groups comprising any of cyclic, Hankel, and Toeplitz matrices, and application of at least one bilinear algorithm to each of the matrices, wherein the applying of the operation to each bilinear algorithm results in only one multiplication along the critical path in a hardware implementation. The block size may be at least a short block size of 12 points, and at least a long block size of 36 points. The applying of each bilinear algorithm may be performed concurrently for at least two short blocks. The MDCT or IMDCT may include at least one 36-point MDCT or IMDCT, and wherein the operation comprises at least 2 processing modules, the modules including at least one 12-point matrix, and at least one of a 6-point CGT or a 6-point DCT-IV.

Similarly, wherein the operation may use the 6-point DCT-IV inside the 36-point MDCT or IMDCT to process the 12-point MDCT or IMDCT in the same MPEG data stream so that the resulting data throughput is selected from the group consisting of at least one 36-point MDCT per cycle, at least one 36-point IMDCT per cycle, at least one 36-point MDCT and one 12-point MDCT per cycle, and at least one 36-point IMDCT and one 12-point IMDCT per cycle.

In another embodiment, the operation further includes expanding 6-point CGT into 6-point DCT-IV to process a second 12-point MDCT or IMDCT, so that the resulting data throughput is selected from the group consisting of at least one 36-point MDCT per cycle, at least one 36-point IMDCT per cycle, and at least two 12-point MDCT per cycle, and at least two 12-point IMDCT per cycle.

In still another embodiment, the operation includes using the same 6-point CGT module for both the 12-point and 36-point MDCT or IMDCT so that the resulting throughput is selected from the group consisting of at least one 12-point MDCT per cycle, at least one IMDCT per cycle, at least one 36-point MDCT per every 2 cycles, and at least one 36-point IMDCT per every 2 cycles. In yet another embodiment, the operation comprises using the 6-point DCT-IV to calculate the 6-point CGT.

The step of applying the operation to the MPEG signal may be performed by a unified accelerator, regardless of whether encoding or decoding the MPEG signal, and regardless of the block size defined for the MPEG signal format.

Also provided herein is a hardware structure for coding and decoding a digital signal in an MPEG format, the structure including a microprocessor, and computer-readable instructions executable by the microprocessor for applying an operation to a MPEG signal, the operation comprising calculation of a forward modified discrete transform (MDCT) or the inverse modified discrete transform (IMDCT), wherein the applying of the operation results in at least one of 9 or less mutually independent multiplications for a 12-point MDCT or IMDCT, or 36 or less mutually independent multiplications for a 36-point MDCT or IMDCT.

According to such a hardware structure, the operation may provide for generation of at least one transform kernel, decomposition of the transform kernel into groups comprising any of cyclic, Hankel, and Toeplitz matrices, and application of at least one bilinear algorithm to each of the matrices, wherein the applying of the operation to each bilinear algorithm results in only one multiplication along the critical path in a hardware implementation.

The hardware structures as further described herein may include computer instructions providing for use of an associated dynamic window switching module and associated buffer memory to provide an efficient memory layout and a data arrangement method to store a plurality of data generated by the MDCT or IMDCT of the operation for providing a reading of a synthesis filter bank module. The operation, dynamic switching window module and the synthesis filter bank module can be implemented in a pipeline process manner. Of course, the writing of the MCDT or IMDCT transform of the sample data contained in each of the memory banks of the dynamic window buffer memory and the reading of the synthesis filter bank can follow a specific sequence. The hardware structure may be a hardware structure design of the post-process portion in the audio decoding process of the Layer3 compression method of the MPEG compression standard (MP3).

According to various embodiments hereof, the block size may include at least a short block size of 12 points, and at least a long block size of 36 points. The applying of each bilinear algorithm may be performed concurrently for at least two short blocks. The MDCT or IMDCT may include at least one 36-point MDCT or IMDCT, and wherein the operation comprises at least 2 processing modules, the modules including at least one 12-point matrix, and at least one of a 6-point CGT or a 6-point DCT-IV. Similarly, the operation may include using the 6-point DCT-IV inside the 36-point MDCT or IMDCT to process the 12-point MDCT or IMDCT in the same MPEG data stream so that the resulting data throughput is selected from the group consisting of at least one 36-point MDCT per cycle, at least one 36-point IMDCT per cycle, at least one 36-point MDCT and one 12-point MDCT per cycle, and at least one 36-point IMDCT and one 12-point IMDCT per cycle.

In still other example embodiments, the operation may also include expanding 6-point CGT into 6-point DCT-IV to process a second 12-point MDCT or IMDCT, so that the resulting data throughput is selected from the group consisting of at least one 36-point MDCT per cycle, at least one 36-point IMDCT per cycle, and at least two 12-point MDCT per cycle, and at least two 12-point IMDCT per cycle. The operation may also include using the same 6-point CGT module for both the 12-point and 36-point MDCT or IMDCT so that the resulting throughput is selected from the group consisting of at least one 12-point MDCT per cycle, at least one IMDCT per cycle, at least one 36-point MDCT per every 2 cycles, and at least one 36-point IMDCT per every 2 cycles. Alternatively, the operation may include using the 6-point DCT-IV to calculate the 6-point CGT.

In still other embodiments, the step of applying the operation to the MPEG signal may be performed by a unified accelerator, regardless of whether encoding or decoding the MPEG signal, and regardless of the block size defined for the MPEG signal format.

Additional features may be understood by referring to the accompanying Drawings, which should be read in conjunction with the following detailed description and Examples.

### DESCRIPTION OF THE DRAWINGS

FIG. 1 is a flow graph for Ref. [9] implementation of N point MDCT.

FIG. 2 is a flow graph for Ref [27] implementation of N point MDCT/IMDCT. Note that SDCT is unnormalized discrete cosine transform.

FIG. 3 is a flow graph for the DCT-IV implementation of N-point MDCT.

FIG. 4 is a flow graph for the DCT-IV implementation of N point IMDCT.

FIG. 5 is a flow graph for the DCT-IV implementation of 2N-point unified MDCT and IMDCT. Note that IMODE=0 for MDCT and IMODE=1 for IMDCT.

FIG. 6 is a flow graph for the DCT-IV implementation of 2N-point unified MDCT and IMDCT with reduced 10 requirement. Note that for MDCT, IMODE=0 and in(i)=x(i), I=0, 1, . . . , 2N−1. For IMDCT, IMODE=1 and in(k)=X(k), k=0, 1, . . . , N−1.

FIG. 7 schematically illustrates a bilinear implementation of an 8-point DCT-IV in accordance with an example embodiment hereof.

FIG. 8. schematically illustrates an implementation of 16-point MDCT and IMDCT based on the 8-point DCT-IV in accordance with an example embodiment hereof.

FIG. 9 schematically illustrates a unified implementation of the 16-point MDCT and IMDCT employing one 8-point DCT-IV in accordance with an example embodiment hereof Note that for MDCT, IMODE=0, in(i)=x(i), 0≦i<16. For IMDCT, IMODE=1, in(k)=X(k), 0≦k<8.

FIG. 10 illustrates the delay in nsec (on horizontal axis) and normalized area (on vertical axis) for various implementations of 8 and 16 point MDCTs. Note that FIG. 9 is a unified MDCT and IMDCT architecture, while all others compute MDCT only.

FIG. 11 is a flow graph for 2·3″-point bilinear DCT-IV.

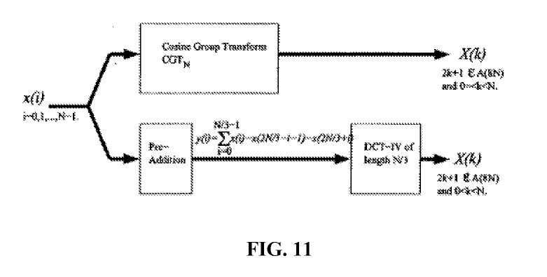

FIG. 12 is a flow graph for cosine group transform of 2·3″-point bilinear DCT-IV.

FIG. 13 is a bilinear implementation of a 6-point DCT-IV in accordance with an example embodiment hereof.

FIG. 14. schematically illustrates implementations of 12-point MDCT and IMDCT based on 6-point DCT-IV.

FIG. 15 illustrates the delay in nsec (on horizontal axis) and normalized area (on vertical axis) for various implementations of 12-point MDCT and IMDCT.

FIG. 16 is a bilinear implementation of multidimensional convolution involved in the 18-point DCT-IV.

FIG. 17 is a bilinear implementation of the 18-point DCT-IV in accordance with an example embodiment hereof.

FIG. 18 schematically illustrates a bilinear implementation of the 36-point MDCT in accordance with an example embodiment hereof.

FIG. 19 schematically illustrates a bilinear implementation of the 36-point IMDCT in accordance with an example embodiment hereof.

FIG. 20 illustrates the delay in nsec (on horizontal axis) and normalized area (on vertical axis) for various implementations of 36-point MDCT and IMDCT.

FIG. 21 schematically illustrates the bilinear implementation of the unified 12 and 36 point MDCT and IMDCT according to example embodiment “architecture A” hereof.

FIG. 22 schematically illustrates the bilinear implementation of the unified 12 and 36 point MDCT and IMDCT according to example embodiment “architecture B” hereof.

FIG. 23 schematically illustrates the bilinear implementation for the pipelined unified 12 and 36 point MDCT and IMDCT according to example embodiment “architecture C” hereof.

FIG. 24 illustrates the delay in nsec (on horizontal axis) and normalized area (on vertical axis) for unified 12 and 36 point MDCT and IMDCT example architectures (A, B and pipeline), with comparison to the 36-point MDCT architectures in literature.

### DETAILED DESCRIPTION

The forward and inverse modified discrete cosine transforms (MDCT/IMDCT) are used as analysis and synthesis filter bank in transform/subband coding schemes, such as the time domain aliasing cancellation (TDAC)[1] and the modulated lapped transforms (MLT) [2]. The MDCT and IMDCT are basic computing elements in many transform coding standards [3,4]. Since MDCT and IMDCT require intensive computations, fast and efficient algorithms for these transforms are keys to the realization of high quality audio and video compressions.

There have been many fast algorithms proposed for the MDCT/IMDCT. Based on the symmetry of the transform matrix, Malvar [8] converts an N-point windowed MLT into an N/2 point type-IV discrete sine transform (DST-IV). Duhamel et al. [9] computes the MDCT/IMDCT through the fast Fourier transform (FFT). An N/2 point DCT is reduced to an N/4 point complex-valued FFT. Overall arithmetic complexities between the two algorithms are similar. FFT algorithm has the advantage in hardware realization, since existing FFT hard macro can be used. See, e.g. [10]. These algorithms are formulated for data length 2″ and do not directly work on composite data lengths. In [11, 12, and 13], the MDCT and IMDCT are computed using recursive kernels. Recursive kernels require less hardware at the expensive of extending the critical path.

Many existing applications of MDCT/IMDCT however, use composite data lengths. For example, MPEG-1/2 layer III (MP3) specifies two frames consisting of 1152 and 384 data samples. The switching between different sample sizes, plays a crucial role in reducing the appearance of per-echoes in frequency coding of audio signals. These frames are further divided into 32 subbands. A long block processes 36 data samples and a short block with 12 data samples. If implemented as referenced by the ISO, the arithmetic complexity is N×N/2 multiplications and (n−1)×N/2 additions. Britanak and Rao [14] have designed efficient MDCT algorithms for MP3 audio. Their algorithms are based on Given's rotations. Depending on block sizes, either a 3-point or a 9-point DCT and DST modules are used to obtain the results. For MDCT, DCT and DST used are of type-II. For IMDCT, they are of type-III. Their approach is further refined by Nikolajevic and Fettweis [15], where the number of additions is greatly reduced while the multiplication count remains the same. In [16], Lee starts MDCT/IMDCT computations in DCT-IV forms, and successively transforms the DCT-IV to scaled DCT-IIs. The scaled DCT is used for both MDCT and IMDCT. Several long recursive computations exist in Lee's algorithm. These structures contribute to a lower computational requirement, especially for the multiplications. However for hardware implementations, the critical path is extended and the output timing is un-balanced. Recently, Cheng an Hsu [17] applied matrix factorization schemes to further explore the relationship between DCT and MDCT. Their algorithms however, do not directly address the critical path delay.

In this application, we present bilinear algorithms to compute the MDCT/IMDCT through DCT-IV. Bilinear algorithm minimizes multiplication operation along the critical path, and is known as a hardware efficient algorithm for discrete Fourier transform (DFT) [18]. Using group theories, the transform kernel is first decomposed into groups of cyclic and Hankel product matrices. Then bilinear algorithms are used to efficiently evaluate these groups. When implemented in VLSI with fixed point arithmetics, the critical path delay can be notably improved (20% to 30%) faster than existing solutions). This is because sub-groups can be computed in parallel and there is only one multiplication along the critical path.

The group theoretic approach to the matrix decomposition, also presents a unique opportunity to unify the processing of short block and the long block for the first time. We propose three different fast algorithms and VLSI architectures that can process not only the forward and inverse transforms, but also for different block sizes. These unified architectures, being bilinear in nature, are faster than single-functioned existing designs.

Some advantages and improvements over existing methods include, by way of non-limiting example: (1) Efficient bilinear algorithms for MDCT and IMDCT of both short and long block sizes; (2) Improved critical path delay of VLSI architecture for MDCT and IMDCT of both short and long block sizes (20% to 30% faster circuit); (3) Type-(1x) unified algorithm and architecture for MP3 audio (forward/inverse and short/long), capable of processing 1 long block or 1 short block per cycle; (4) Type-(2x) unified algorithm and architecture for MP3 audio (forward/inverse and short/long), capable of processing 1 long block or 2 short blocks per cycle; (5) Pipelined unified algorithm and architecture for MP3 audio (forward/inverse and short/long), capable of processing 0.5 long block or 1 short block 1 per cycle; and (6) With pipelined architecture, the number of outputs can be reduced by ⅓, further improving the silicon foot print.

Arthimetic complexity and critical path comparisons are summarized below for 1 block size computation. Scale by 32 to obtain the processing requirement for one frame size.

TABLE A
Complexity and delay for 12-point MDCT/IMDCT
for MP3 audio short block

| Algorithm | Arithmetic complexity | Critical path delay |
|---|---|---|
| MDCT proposed | 12M + 31A | M + 6A |
| MDCT ref. [14] | 11M + 39A | 2M = \hat{ }A |
| MDCT ref. [15] | 13M + 27A | 2M + 5A |
| MDCT ref. [16] | 11M + 29A | 3M + 7A |
| IMDCT herein | 12M + 25A | M + 5A |
| IMDCT ref. [14] | 11M + 33A | 2M + 5A |
| IMDCT ref. [15] | 13M + 21A | 2M + 4A |
| IMDCT ref. [16] | 11M + 23A | 3M + 6A |

TABLE B
Complexity and delay for 36-point
MDCT/IMDCT for MP3 audio long block

| Algorithm | Arithmetic complexity | Critical path delay |
|---|---|---|
| MDCT proposed | 39M + 154A | M + 10A |
| MDCT ref. [14] | 47M + 165A | 2M + 9A |
| MDCT ref. [15] | 47M + 129A | 2M + 8A |
| MDCT ref. [16] | 43M + 133A | 3M + 22A |
| IMDCT herein | 39M + 136A | M + 9A |
| IMDCT ref. [14] | 51M + 151A | 2M + 8A |
| IMDCT ref. [15] | 51M + 115A | 2M + 7A |
| IMDCT ref. [16] | 43M + 115A | 3M + 21A |

TABLE C
Complexity and delay for unified MDCT/IMDCT algorithms

| Algorithm | Arithmetic complexity | Critical path delay |
|---|---|---|
| Unified (1x) | 39M + 154A | M + 10A |
| Unified (2x) | 42M + 158A | M + 10A |
| Pipeline | 30M + 133A | M + 6A (1 short block) |
| | | 2M + 12A (1 long block) |

Possible variations and modifications: The group generator used in decomposing the kernel matrix is not unique. One can select a different generator and obtain a similar signal flow diagram. However for the given application (MP3 audio), the choices of generator are limited and can exhaustively listed.

Features believed to be new: (1) Bilinear algorithm for 12-point forward and inverse MDCT (MP3 audio short block). (2) Bilinear algorithm for 36-point forward and inverse MDCT (MP3 audio long block). (3) Fast algorithm and unified architecture for MDCT/IMDCT 1 long block or 1 short block per cycle. (4) Fast algorithm and unified architecture for MDCT/IMDCT 1 long block or 2 short blocks per cycle. (5) Pipelines algorithm and unified architecture for MDCT/IMDCT 0.5 long block and 1 short block per cycle.

The inventors have developed useful methods for unifying the MDCT computations in MP3 audio processing for both encoder and decoder for different frame sizes. All published designs have separated modules based on frame choice. In software application, the bilinear algorithm has smaller code size and hence less memory requirement. In hardware application, the structured bilinear circuit is faster and smaller. The proposed algorithm provides a complete solution to MP3 audio processing requirement.

The foregoing Detailed Description is further exemplified for the following Examples, which should not be construed as limiting.

### Example Architectures

Forward and inverse modified discrete cosine transforms (MDCT/IMDCT) are widely used for subband coding in the analysis and synthesis filter banks of time domain aliasing cancellation (TDAC). Many international audio coding standards rely heavily on fast algorithms for the MDCT/IMDCT. Presented herein are hardware efficient bilinear algorithms to compute MDCT/IMDCT of 2″ and 4·3ⁿ points. The algorithms for composite lengths have practical applications in MPEG-1/2 audio layer III (“MP3”) encoding and decoding. The MDCT/IMDCT can be converted to type-IV discrete cosine transforms (DOT-IV). Using group theory, the present approach decomposes DOT-TV transform kernel matrix into groups of cyclic and Hankel matrices. Bilinear algorithms are then applied to efficiently evaluate these groups. When implemented in VLSI, the algorithms greatly improve the critical path delay as compared with the existing solutions. This is due to the fact that bilinear algorithms employ only one multiplication along the critical path. For MP3 audio, several example versions of the unified hardware architectures for both the short and long blocks are described herein.

The forward and inverse modified discrete cosine transforms (MDCT/IMDCT) are used as analysis and synthesis filter bank in transform/subband coding schemes, such as the time domain aliasing cancellation (TDAC) [41] and the modulated lapped transform (MLT) [31]. The MDCT/IMDCT are basic computing elements in many transform coding standards [38, 39]. Since the MDCT and IMDCT require intensive computations, fast and efficient algorithms for theses transforms is a key to the realization of high quality audio and video compression schemes [50, 51, 63].

The N-point modified discrete cosine transform (MDCT) of a sequence {x(i)} is defined as

$$X ( k ) = {\sum }_{i = 0}^{N - 1} x ( i ) cos ( \frac{π ( 2 i + 1 + \frac{N}{2} ) ( 2 k + 1 )}{2 N} ) , \\ k = 0 , 1 , … , \frac{N}{2} - 1. \qquad ( 4.1 )$$

Note the similarity between the kernel of the MDCT and that of the discrete cosine transform (DCT). However unlike a DCT, MDCT converts N signal samples into only N/2 transform samples.
There have been many fast algorithms for the MDCT and its inverse, IMDCT. Based on the symmetry of the transform matrix, Malvar [30] converts an N-point MDCT into an N/2-point type-IV discrete sine transform (DST-IV). Duhamel et al. [18] compute the MDCT/IMDCT through the fast Fourier transform (FFT). An N-point DCT is reduced to an N/4-point complex-valued FFT. Though the overall arithmetic complexities between the two algorithms are similar, FFT algorithm has the advantage of existing hardware realization [24]. In [12, 14, 36], the MDCT and IMDCT are computed using recursive kernels. Recursive implementations require less hardware at the expense of extending the critical path.

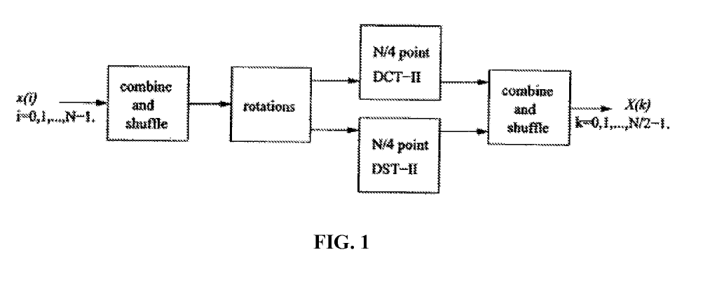

Unfortunately, most MDCT algorithms are formulated for N=2″ and do not directly apply to composite data lengths. Many existing applications of MDCT/IMDCT however, use composite data lengths. For example, MPEG-1/2 layer III (MP3) audio format specifies two frames consisting of 1152 and 384 data samples. These frames are further partitioned into 32 subbands. A long block processes 36 data samples and a short block 12 data samples. If implemented directly as in the ISO, the arithmetic complexity of this composite N-point MDCT is N²/2 multiplications and (N²−N)/2 additions. Britanak and Rao [8, 9] have designed efficient MDCT algorithms for MP3 audio. Their algorithms are based on Given's rotations. Depending on block sizes, 3 or 9 point DCT and DST modules are then used to obtain the results. For MDCT, the DOT and DST used are of type-II. For IMDCT, they are of type-III. Their approach is further refined by Nikolajevic and Fettweis [37], where the number of additions are reduced while the multiplication count remains the same. Referring to the attached drawings, FIG. 1 shows the flow graph of MDCT computation based on Given's rotation method.

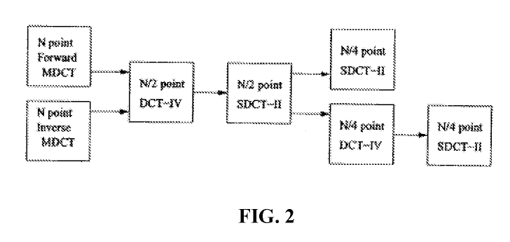

In [27], Lee expresses MDCT/IMDCT computations in the DOT-TV format, and successively transforms the DOT-TV to scaled DCT-IIs. The un-normalized or scaled DCTs (SDCT) are used for both MDOT and IMDCT. Unfortunately, this algorithm has several long recursive computations. These contribute to lower computational complexity, especially for the multiplications. However in hardware implementations, they extend the critical path and the output timing is un-balanced. Flow graph for this approach is shown in FIG. 2. Recently Cheng and Hsu [15] have applied matrix factorization schemes to further explore the relationships between the DCT and the MDCT. Their algorithms however, do not directly address the critical path delay.

Presented herein are bilinear algorithms to compute the MDCT/IMDCT through DCT-IV. This allows us to minimize multiplications along the critical path. Using group theory, we decompose the transform kernel into cyclic and Hankel matrix products. Bilinear algorithms are then used to efficiently evaluate these matrix products. We show that when implemented in VLSI with fixed-point arithmetic, our approach significantly reduces the critical path delay.

Described herein below are example steps of transforming MDCT/IMDCT to DCT-IV. Bilinear algorithms for 2ⁿ-point MDCT/IMDCT are also presented, including bilinear algorithms for MDCT/IMDCT with composite lengths of 4·3ⁿ. In particular, a 12-point MDCT/IMDCT is used for MP3 short block processing as a 6-point DCT-IV. The MP3 long block of 36-point MDCT/IMDCT is computed by an 18-point DCT-IV. For all DCT-IV algorithms, group structures, arithmetic complexities, and critical path delays that are associated with the bilinear algorithm implementation are discussed. In particular for the MP3 application, three example versions of the unified hardware architecture for both the short and long blocks, and the forward and inverse transforms are presented.

An N-point MDCT uses N signal samples to create N/2 transform samples. The first step in the computation of MDCT therefore involves converting this N×N/2 kernel into a kernel of a known square transform. An N-point MDCT/IMDCT can be transformed into an N/2-point type-IV DCTs [12, 27, 30, 31].

The forward MDCT is defined as

$$X ( k ) = {\sum }_{i = 0}^{N - 1} x ( i ) cos ( \frac{π ( 2 i + 1 + \frac{N}{2} ) ( 2 k + 1 )}{2 N} ) , \\ k = 0 , 1 , … , \frac{N}{2} - 1. \qquad ( 4.2 )$$

Introduce a new data sequence

$$y ( i ) = \{ \begin{matrix}- x ( i + \frac{3 N}{4} ) & if 0 \leq i < N / 4 , \\ x ( i - \frac{N}{4} ) & if N / 4 \leq i < N .\end{matrix} \qquad ( 4.3 )$$

Then (4.2) can be written as

$$X ( k ) = {\sum }_{i = 0}^{N - 1} y ( i ) cos ( \frac{π ( 2 i + 1 ) ( 2 k + 1 )}{2 N} ) , \\ k = 0 , 1 , … , \frac{N}{2} - 1. \qquad ( 4.4 )$$

The cosine term in (4.4) satisfies the following relation

$$cos ( \frac{π ( 2 i + 1 ) ( 2 k + 1 )}{2 N} ) = - cos ( \frac{π ( 2 N - 1 - 2 i ) ( 2 k + 1 )}{2 N} ) . \qquad ( 4.5 )$$

Then defining

z(i)=y(i)−y(N−1−i)0≦i<N/2, (4.6)

an N-point MDCT can be expressed as an N/2-point DCT-IV as

$$X ( k ) = {\sum }_{i = 0}^{\frac{N}{2} - 1} z ( i ) cos ( \frac{π ( 2 i + 1 ) ( 2 k + 1 )}{2 N} ) , k = 0 , 1 , … , \frac{N}{2} - 1. \qquad ( 4.7 )$$

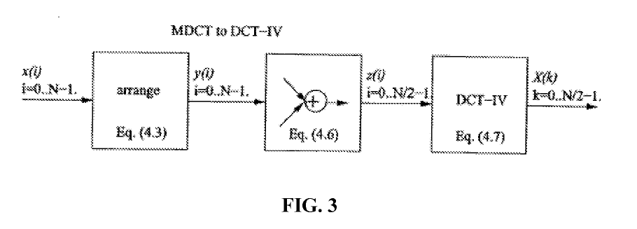

A general MDCT flow graph based on DCT-IV transformation is shown in FIG. 3.

The inverse MDCT (IMDCT) is defined as

$${x}^{′} ( i ) = \frac{2}{N} {\sum }_{k = 0}^{\frac{N}{2} - 1} X ( k ) cos ( \frac{π ( 2 i + 1 + \frac{N}{2} ) ( 2 k + 1 )}{2 N} ) , \\ i = 0 , 1 , … , N - 1. \qquad ( 4.8 )$$

To obtain the IMDCT, first compute the N/2-point type-IV DCT of X as

$${z}^{′} ( i ) = \frac{2}{N} {\sum }_{i = 0}^{\frac{N}{2} - 1} X ( k ) cos ( \frac{π ( 2 i + 1 ) ( 2 k + 1 )}{2 N} ) , \\ i = 0 , 1 , … , \frac{N}{2} - 1. \qquad ( 4.9 )$$

Applying the symmetry property (4.5), and defining a new data sequence

$${y}^{′} ( i ) = \{ \begin{matrix}{z}^{′} ( i ) & if 0 \leq i \leq N / 2 - 1 , \\ - {z}^{′} ( N - 1 - i ) & if N / 2 \leq i < N ,\end{matrix} \qquad ( 4.10 )$$

the IMDCT output x′(i) can then be recovered as

$${x}^{′} ( i ) = \{ \begin{matrix}{y}^{′} ( i + \frac{N}{4} ) & 0 \leq i \leq \frac{3 N}{4} - 1 , \\ - {y}^{′} ( i - \frac{3 N}{4} ) & \frac{3 N}{4} \leq i \leq N - 1.\end{matrix} \qquad ( 4.11 )$$

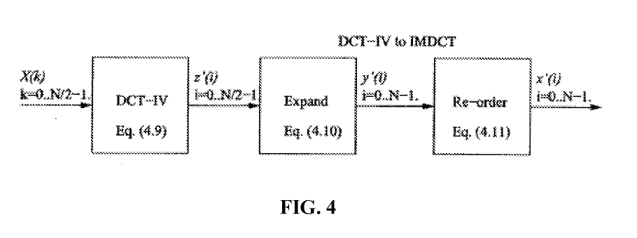

An IMDCT flow graph based on DOT-TV transformation is shown in FIG. 4.

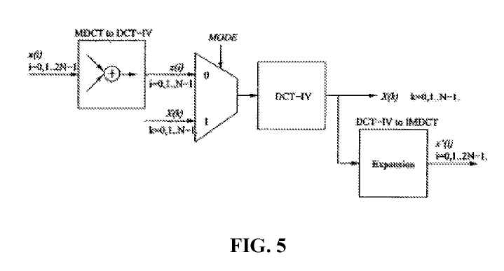

The DCT-IV transformation has significant implication on implementations, especially for hardware. It is clear from FIGS. 4.3 and 4.4 that a common DCT-IV module can be shared for both the forward and inverse transforms. Unified hardware architecture for the MDCT and IMDCT is shown in FIG. 5. Note that the data sample is scaled to 2N points so that the core computation module becomes an N-point DCT-IV.

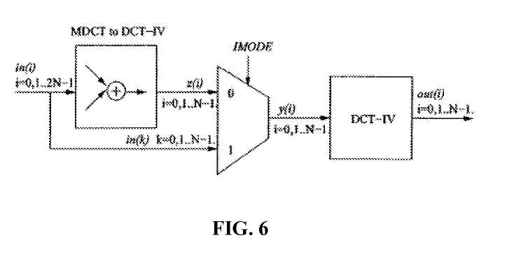

A key challenge to ASIC implementation is the requirement on the number of input and output (I)) pins. From a package point of view, the reduction of pad 10 size has not kept pace with the development of transistor technology. From a macro perspective, all inputs and outputs must observe a minimum spacing requirement to reduce potential cross-talk issue. This constraint on inputs and outputs can be addressed with an improved architecture shown in FIG. 6. On the input side, input pins of IMDCT can be merged with the N input pins of MDCT. For simplicity, we choose the first N input pins of MDCT. On the output side, (4.10) shows that only N outputs of IMDCT are truly unique. Therefore it is possible to keep the N outputs from DCT-IV without scarifying any loss of information. Combing together the input and output reduction techniques, the improved architecture can save up to 50% of the IOs comparing to the implementation in FIG. 5.

By way of further example, for N=r a 2N-point MDCT can be converted to an N-point DCT-IV with N pre-additions. For IMDCT there is no extra computation involved.

To construct a bilinear algorithm for MDCT/IMDCT, it is helpful to understand the group structures within the DCT-IV transform kernel. From (4.7) and (4.9) the transform kernel indices have N points of odd values for (2i+1) and (2k+1), which belongs to an Abelian group A(8N). From group theory, Abelian group A(2ⁿ⁺³)=C2×C₂₊ᵢ, where N=2ⁿ. Thus there exists a cyclic sub-group of size 2N of A(8N). Integer 3 can be used as the generator g of this group. The integers φ(i), i=0, 1, . . . , N−1 are defined in the following lemma (“Lemma 5”) provide the first N odd integers.

Lemma 5 Let N=2ⁿ and A(8N)=C₂×C_{2N}, define function φ(i), 0≦i<N as

$$φ ( i ) = \{ \begin{matrix}{g}^{i} mod 4 N & if {g}^{i} mod 4 N < 2 N \\ 4 N - ( {g}^{i} mod 4 N ) & otherwise .\end{matrix} \qquad ( 4.12 )$$

Then values of φ(i), 0≦i<N give all the odd integers the range 0 to 2N.

Proof Since g ∈ A(8N), φ(i) in (4.12) for every i, 0≦i<N is an odd integer in the range 0 to 2N. Every φ(i), 0≦i<N, is distinct. It would then imply that these φ(i) give all the N odd integers in the range 0 to 2N.

Each φ(i), 0≦i<N, is distinct. In particular if for some 0≦i, j<N, j<N, φ(i))=φ(j), then i=j. Clearly if gⁱ mod 4N and gⁱ mod 4N are both smaller or larger than 2N, then from (4.12), i=j. Assume that gⁱ mod 4N<2N while gⁱ mod 4N>2N. Then from (4.12),

gⁱ mod 4N=4N−(gⁱ mod 4N), orgⁱ=gⁱ mod N.

By squaring both sides, one gets

g²ⁱ=g^{2j} mod 8N, g^{2(i-j)}=1 mod 8N. (4.13)

But since g is the generator of C_{2N}, a cyclic group under the operation of multiplication modulo 8N, the only way (4.13) can be true for 0≦i, j<N is if i=j.

The fact that each odd integer (2i+1) for 0≦i<N can be expressed through the function which is based on a cyclic group allows us to convert the MDCT computation into a cyclic convolution. Define function ψ as follows:

$$ψ ( i ) = \{ \begin{matrix}1 & if {g}^{i} mod 4 N < 2 N , \\ - 1 & otherwise .\end{matrix} \qquad ( 4.14 )$$

One can express the DCT-IV component

$$X ( k ) = {\sum }_{i = 0}^{N - 1} x ( i ) cos ( \frac{π ( 2 i + 1 ) ( 2 k + 1 )}{4 N} )$$

as

$$\begin{matrix}X ( \frac{φ ( k ) - 1}{2} ) = {\sum }_{i = 0}^{N - 1} x ( \frac{φ ( i ) - 1}{2} ) cos ( \frac{πφ ( i ) φ ( k )}{4 N} ) \\ = {\sum }_{i = 0}^{N - 1} x ( \frac{φ ( i ) - 1}{2} ) cos ( \frac{π ( {g}^{i + h} mod 4 N )}{4 N} ) \\ ψ ( i ) ψ ( k ) .\end{matrix} \\ Thus \\ ψ ( k ) X ( \frac{φ ( k ) - 1}{2} ) = {\sum }_{i = 0}^{N - 1} ψ ( i ) x ( \frac{φ ( i ) - 1}{2} ) cos ( \frac{π ( {g}^{i + k} mod 4 N )}{4 N} ) . \qquad ( 4.15 )$$

Equation (4.15) shows that a permuted and sign adjusted input sequence ψ(i)×((φ(i)−1)/2) can be cyclically convolved with a constant sequence cos(π(gⁱ mod 4N)/(4N)) to get the permuted and sign adjusted transform sequence ψ(k)×((φ(k)−1)/2).

The bilinear complexity for 2ⁿ-point DCT-IV is 3ⁿ multiplications and 3(3ⁿ−2ⁿ) additions. The bilinear complexity for 2ⁿ-point MDCT is 3ⁿ⁻¹ multiplications and 3ⁿ−2ⁿ additions. The bilinear complexity for 2ⁿ-point IMDCT is 3¹ multiplications and 3(3ⁿ⁻¹ 2ⁿ⁻¹) additions. Given the complexity requirements, our bilinear algorithm works best at smaller transform sizes where the hardware implementation is possible.

This concept may be illustrated through an 8-point DCT-IV, which is employed in a 16-point MDCT. Let x(i) and X(i), 0≦i<8, denote the input and output samples of the DCT. In this case, g being 3, the values of φ(i) for i=0 through 7 are given by {1, 3, 9, 5, 15, 13, 7, 11}. The consecutive values of ψ(i) are {1, 1, 1, −1, −1, 1, −1, 1}. Using a shorthand notation p for a value of cos(πp/4N) and p̅ be a value of −cos(πp/4N) with N=8, the transform matrix for 8 point DCT-IV can be described as

$$( \begin{matrix}X ( 0 ) \\ X ( 1 ) \\ X ( 4 ) \\ - X ( 2 ) \\ - X ( 7 ) \\ X ( 6 ) \\ - X ( 3 ) \\ X ( 5 )\end{matrix} ) = ( \begin{matrix}1 & 3 & 9 & \overline{5} & \overline{15} & 13 & \overline{7} & 11 \\ 3 & 9 & \overline{5} & \overline{15} & 13 & \overline{7} & 11 & \overline{1} \\ 9 & \overline{5} & \overline{15} & 13 & \overline{7} & 11 & \overline{1} & \overline{3} \\ \overline{5} & \overline{15} & 13 & \overline{7} & 11 & \overline{1} & \overline{3} & \overline{9} \\ \overline{15} & 13 & \overline{7} & 11 & \overline{1} & \overline{3} & \overline{9} & 5 \\ 13 & \overline{7} & 11 & \overline{1} & \overline{3} & \overline{9} & 5 & 15 \\ \overline{7} & 11 & \overline{1} & \overline{3} & \overline{9} & 5 & 15 & \overline{13} \\ 11 & \overline{1} & \overline{3} & \overline{9} & 5 & 15 & \overline{13} & 7\end{matrix} ) ( \begin{matrix}x ( 0 ) \\ x ( 1 ) \\ x ( 4 ) \\ - x ( 2 ) \\ - x ( 7 ) \\ x ( 6 ) \\ - x ( 3 ) \\ x ( 5 )\end{matrix} ) \qquad ( 4.16 )$$

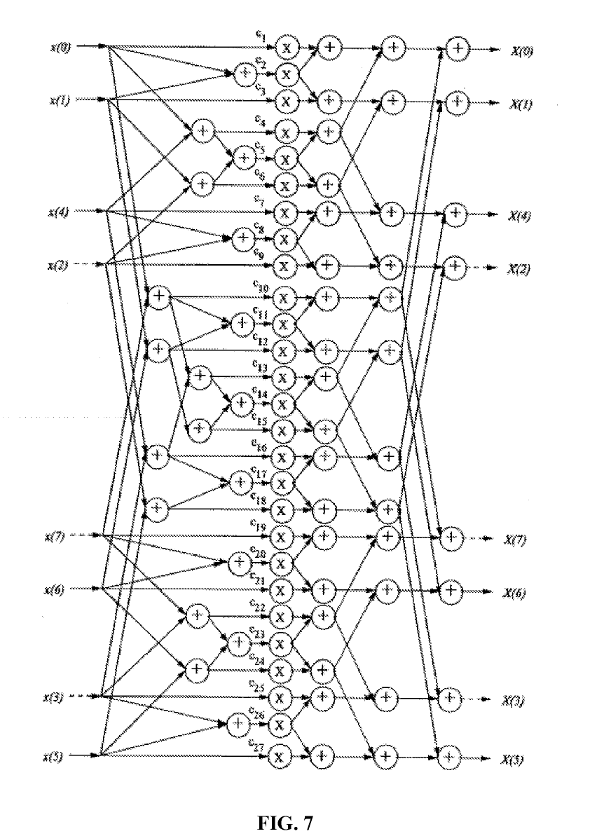

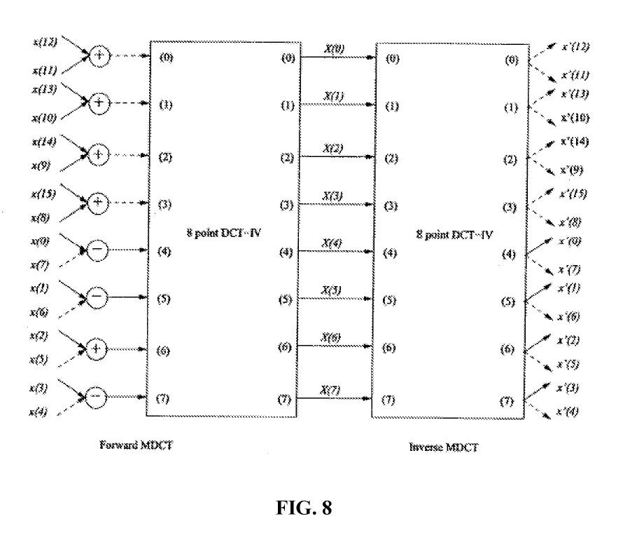

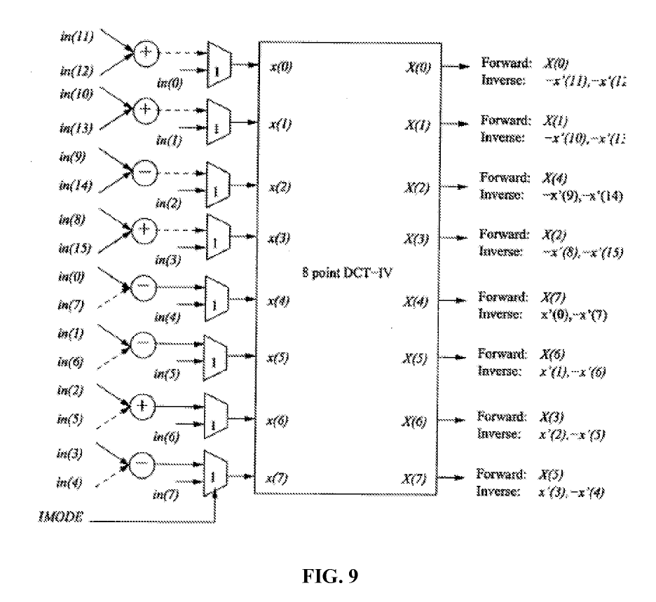

A Hankel matrix product is derived and efficient bilinear algorithm can then be applied to compute the transform. This algorithm is shown in FIG. 7. Individual architecture for 16-point MDCT and IMDCT based on this 8-point DCT is shown in FIG. 8, whereas a unified architecture is shown in FIG. 9. A solid line means a transfer function of 1, a dashed line means a transfer function of −1. The multiplication coefficients are listed in Table 1.

TABLE 1
Multiplication coefficients used in FIG. 7.

| Coefficient | Value | Coefficient | Value | Coefficient | Value |
|---|---|---|---|---|---|
| c₁ | −2.3342 | c₂ | 2.0200 | c₃ | −1.5097 |
| c₄ | 2.7607 | c₅ | −1.3533 | c₆ | 2.2505 |
| c₇ | −3.1108 | c₈ | 2.6005 | c₉ | −3.6363 |
| c₁₀ | 0.8561 | c₁₁ | −0.1811 | c₁₂ | 0.4033 |
| c₁₃ | −1.2444 | c₁₄ | 0.4714 | c₁₅ | −1.4666 |
| c₁₆ | 1.2062 | c₁₇ | −1.4283 | c₁₈ | 1.7891 |
| c₁₉ | 0.6220 | c₂₀ | −1.6577 | c₂₁ | 0.7032 |
| c₂₂ | −0.2719 | c₂₃ | 0.4105 | c₂₄ | 0.6827 |
| c₂₅ | 0.6985 | c₂₆ | 0.2561 | c₂₇ | 0.0581 |

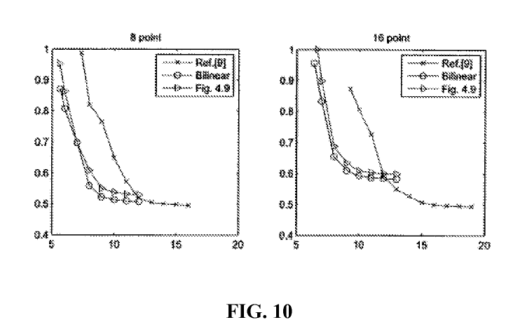

For lengths 8 and 16, the algorithms for MDCT may be compared to [9], which offers a regular structure based on Given's Rotation. The complexities and critical path delays are shown in Table 2. The algorithms are implemented in 16-bit fixed arithmetic with TSMC 90 nm CMOS standard cell library. The normalized area and speed comparison of the resultant circuits is shown in FIG. 10. For 8-point MDCT, the top speed of the bilinear implementation is 23% higher than that of [9]. For 16-point MDCT, our speed advantage is over 31%. In fact, the top speed of 16-point bilinear implementation is even 13% faster than that of the 8-point implementation of [9]. Given the same speed, the area for 8-point bilinear circuits can be as much as 32% smaller than that of [9]. For 16-point, the circuit can be as much as 26% smaller.

TABLE 2
Complexities of various 8 and 16 point MDCT algorithms.

| Transform | Algorithm | Arithmetic complexity | Critical delay |
|---|---|---|---|
| 4-point DCT-IV | Proposed | 9M + 15A | M + 4A |
| 8-point MDCT | Proposed | 9M + 19A | M + 5A |
| 8-point MDCT | Ref. [9] | 8M + 24A | 2M + 5A |
| 8-point DCT-IV | Proposed | 27M + 55A | M + 6A |
| 16-point MDCT | Proposed | 27M + 63A | M + 7A |
| 16-point MDCT | Ref. [9] | 22M + 60A | 2M + 7A |

Note that M and A refer to multiplication and addition, respectively.

In addition, the MDCT bilinear implementations are based on DCT-IV transform. This permits simple unified architecture for both the forward and the inverse implementations. The speed and area of these unified implementations are close to the implementations of the bilinear MDCT.

The MDCT/IMDCT algorithms for composite lengths of 4·3ⁿ points where n>0, have found many practical applications in audio coding standards. In particular, 12-point MDCT/IMDCT is used for the short block and 36-point MDCT/IMDCT is used for the long block of MPEG-1/2 layer III (MP3) audio processing.

The algorithm for 4−3ⁿ-point MDCT can be designed following an approach similar to the one in Section 4.2, i.e., a 2N-point MDCT is first converted to an N-point DCT-IV as

$$X ( k ) = {\sum }_{i = 0}^{N - 1} x ( i ) cos ( \frac{π ( 2 i + 1 ) ( 2 k + 1 )}{4 N} ) , k = 0 , 1 , … , N - 1. \qquad ( 4.17 )$$

An N-point IMDCT is computed directly from an N-point DCT-IV to obtain one half of the outputs. The other half is redundant and can be obtained with trivial sign changes.

The MDCT of any even length can be computed via a DCT-IV [symbol] length. Let N=2·3ⁿ where n>0. The symbol Xᵣ, is used to indicate a DCT-IV of [symbol] 2·3ⁿ. Consider the group A(8N)={0≦i<8N|gcd(i, 8N)=1}. The computation shown in [symbol] 11 uses transform division of DCT-IV kernel matrix based on A(8N). For MDCT, it is a frequency division scheme; for IMDCT, a time division scheme.

Consider first the computation of Xₙ(k), where (2k+1)∉ A(8N), i.e. (2k+1) is a multiple of 3. In this case, it can be shown that the multiplication coefficients for x(i), x(i), x(2N/3−i−1) and x(2N/3+i) are related. In particular,

$$cos ( \frac{π ( 2 i + 1 ) ( 2 k + 1 )}{4 N} ) = - cos ( \frac{π ( 2 ( 2 N / 3 - i - 1 ) + 1 ) ( 2 k + 1 )}{4 N} ) = - cos ( \frac{π ( 2 ( 2 N / 3 + i ) + 1 ) ( 2 k + 1 )}{4 N} ) . \qquad ( 4.18 )$$

To take advantage of (4.18), define

z(i)=x(i)−x(2N/3−i−1)−x(2N/3+i) i=0, 1, . . . , (N/3)−1.

Then it is clear that for (2k+1)∉ A(8N),

$$\begin{matrix}{X}_{n} ( k ) = {\sum }_{i = 0}^{N / 3 - 1} z ( i ) cos ( \frac{π ( 2 i + 1 ) ( 2 k + 1 )}{4 N} ) \\ {Z}_{n - 1} ( k ) , k = 0 , 1 , … , N / 3 - 1 ,\end{matrix} \qquad ( 4.19 )$$

where Zₙ₋₁ (k) is the 2·3ⁿ⁻¹ point DCT-IV of sequence {z(i)}. Therefore the DCT-IV components with index values (2k+1) are multiples of 3 can be computed directly from the DCT-IV of a sequence {z(i)} of a smaller length (N/3).

To compute Xₙ(k) where (2k+1)∈A(8N), A(8N) forms a group under the operation of multiplication modulo 8N. This computation of cosine transform with the transform indices is restricted to a group as the 2·3ⁿ-point Cosine Group Transform, CGT_{N}. Thus we have

$${CGT}_{N} ( k ) = {\sum }_{i = 0}^{N - 1} x ( i ) cos \frac{π ( 2 i + 1 ) ( 2 k + 1 )}{4 N} , \\ 0 \leq k < N , 2 k + 1 ∈ A ( 8 N ) . \qquad ( 4.20 )$$

By separating the summation in (4.20) in two summations depends on whether (2i+1) belongs to A(8N) or not. The results of these are combined using |CGT_{N}| additions later. When (2i+1) ∈ A(8N), we can permute the signal and transform components to convert the partial kernel to a direct product of cyclic groups. This permutation and computation thus depends on the group structure and is illustrated later in this section.

When (2k+1) ∈ A(8N) but (2i+1) ∉A(8N), (2i+1) is a multiple of 3. In this case, only the first N/3 components of the cosine group transform are independent because

$$\begin{matrix}{CGT}_{N} ( k ) = - {CGT}_{N} ( 2 N / 3 - k - 1 ) \\ = - {CGT}_{N} ( 2 N / 3 + k ) .\end{matrix} \qquad ( 4.21 )$$

It is therefore sufficient to compute CGT_{N}(k) only for (2k+1) ∈ A(8N), 0≦k<N/3, i.e., (2k+1) ∈ A(8N/3). Also, since (2i+1) ∉ A(8N), one has (2i+1) ∉ A(8N/3).

### Thus

$$\begin{matrix}{CGT}_{N} ( k ) = {\sum }_{( 2 i + 1 ) ∉ A ( 8 N / 3 )} x ( i ) cos ( \frac{2 π ( 2 i + 1 ) ( 2 k + 1 )}{4 N} ) \\ = {\sum }_{i = 0}^{N / 3 - 1} {x}^{′} ( i ) cos ( \frac{2 π ( 2 i + 1 ) ( 2 k + 1 )}{4 N} ) , \\ ( 2 k + 1 ) ∈ A ( 8 N / 3 ) , \\ = {CGT}_{N / 3} ( k ) .\end{matrix} \qquad ( 4.22 )$$

Note that the sequence {x′(i)} in (4.22) is defined as x′ (i)=x(3i+1), 0≦i<N/3. Further, CGT_{N/3} in (4.22) represents the N/3 point cosine group transform of {x′(i)}.

The relationship (4.21) between transform components is essentially the analog of signal domain relation (4.18) and is due to the symmetry of the kernel. It points to an alternative division scheme where transform components are first evaluated upon the signal index i with respect to A(N). For (2i+1) ∉ A(N), we then further separate the cosine group transform based on the relationship between A(N) and the transform index k. The motivation behind the signal division scheme is that some computations for (4.19) can be shared with those for the CGT_{N} where (2i+1) ∈ A(8N). A reduced complexity for 6-point DCT-IV is described elsewhere herein. The transform division on the other hand, permits simpler pipelining and can also reduce the number of output pins for large transform sizes. Also, the advantage of transform division architecture are discussed in detail elsewhere herein.

When (2k+1) ∈ A(8N) and (2i+1) ∈ A(8N), the computation turns into a multi-dimensional convolution. This convolution can be described by the structure of A(8N)=A(16 3ⁿ)=C₂×C₄×C_{2·3}ⁿ⁻¹. Let h and g denote the generators of C4 and C_{2·3}. −1 respectively. Define a function φ(a, b) as follows:

$$φ ( a , b ) = \{ \begin{matrix}{h}^{a} {g}^{b} & if 0 < {h}^{a} {g}^{b} < 2 N , \\ 4 N - {h}^{a} {g}^{b} & if 2 N < {h}^{a} {g}^{b} < 4 N , \\ {h}^{a} {g}^{b} - 4 N & if 4 N < {h}^{a} {g}^{b} < 6 N , \\ 8 N - {h}^{a} {g}^{b} & if 6 N < {h}^{a} {g}^{b} < 8 N .\end{matrix} \qquad ( 4.23 )$$

Note that in (4.23), the product h^{a}g^{b} is always computed modulo 8N. Defined as above, function φ(a, b) for 0≦a<2 and 0≦b<2·3ⁿ⁻¹ produces all integers within A(8N) which are less than 2N. Thus if A(8N) is considered to be made up of integers of the type (2i+1), then the values of φ described above produce all (2i+1) ∈ A(8N) corresponding to 0≦i<N.
Define a sign function ψ(a, b) as

$$ψ ( a , b ) = \{ \begin{matrix}- 1 & if 2 N < {h}^{a} {g}^{b} < 6 N , \\ + 1 & otherwise .\end{matrix} \qquad ( 4.24 )$$

With functions φ(a, b) and ψ(a, b) defined in (4.23) and (4.24), one can express the computation

$$Y ( k ) = {\sum }_{i = 0}^{N - 1} x ( i ) cos ( \frac{π ( 2 i + 1 ) ( 2 k + 1 )}{4 N} ) 0 \leq k < N , \\ k ∈ A ( 8 N ) , \qquad ( 4.25 )$$

as a convolution. Using the equivalence between φ(a, b) values and (2i+1), (2k+1) ranges, one gets

$$Y ( {a}^{′} , {b}^{′} ) = {\sum }_{a = 0}^{1} {\sum }_{b = 0}^{2 \cdot {3}^{n - 1} - 1} x ( a , b ) cos ( \frac{πφ ( a , b ) φ ( {a}^{′} , {b}^{′} )}{4 N} ) 0 \leq {a}^{′} < 2 , \\ 0 \leq {b}^{′} < 2 \cdot {3}^{n - 1} . \qquad ( 4.26 )$$

In (4.26), x(i) is relabeled as x(a, b) where φ(a, b)=2i+1. Similarly Y(k) is relabeled as Y(a′, b′) where φ(a′, b′)=2k+1. Using the definitions of φ(a, b) and ψ(a, b), one gets from (4.26),

$$Y ( {a}^{′} , {b}^{′} ) = {\sum }_{a = 0}^{1} {\sum }_{b = 0}^{2 \cdot {3}^{n - 1} - 1} x ( a , b ) cos ( \frac{πφ ( a , b ) φ ( {a}^{′} , {b}^{′} )}{4 N} ) 0 \leq {a}^{′} < 2 , \\ 0 \leq {b}^{′} < 2 \cdot {3}^{n - 1} . \qquad ( 4.26 )$$

Equation (4.27) can be rewritten as

$$ψ ( {a}^{′} , {b}^{′} ) Y ( {a}^{′} , {b}^{′} ) = {\sum }_{a = 0}^{1} {\sum }_{b = 0}^{2 \cdot {3}^{n - 1} - 1} x ( a , b ) ψ ( a , b ) cos ( \frac{π {h}^{a + {a}^{′}} {g}^{b + {b}^{′}}}{4 N} ) . \qquad ( 4.28 )$$

Equation (4.28) shows that the permuted and sign adjusted values of Y(k) are obtained by a multi-dimensional operation of permuted and sign adjusted signal samples with a constant sequence made up of cosine terms. In one dimension, this operation represents a 2·3ⁿ⁻¹-point cyclic convolution. In other dimensions, it is a 2-point Hankel product.

One can verify that h can always be chosen as h=2N+1. There are also other values of h which would work as well. Similarly, one can choose g from amongst many possible generators of the cyclic group C_{2·3}ⁿ⁻¹⊂ A(8N). Finally the 2 3ⁿ⁻¹⁻ point cyclic convolution can itself be carried out as a two dimensional convolution with lengths 2 and 3ⁿ⁻¹ along the two dimensions. Since an algorithm with a lower computational complexity is desirable, one can use the value of (m+n)/a to determine the decomposition order of bilinear algorithm (n, a, m), where n is the length of the input vector, a its additive complexity and m its multiplicative complexity.

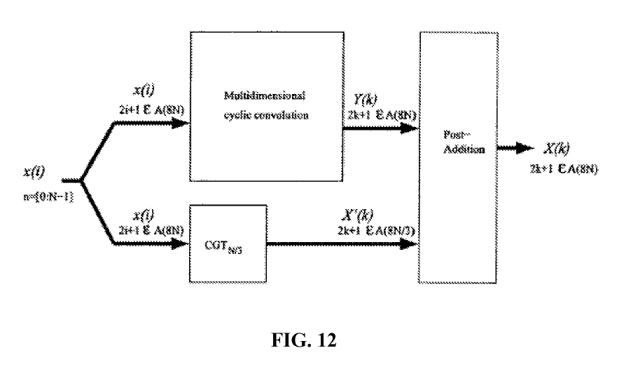

The decomposition of CGT_{N} is summarized in FIG. 12. It shows that the computation of CGT_{A}r breaks down into two independent computations, one involving a multi-dimensional cyclic convolution and the other, the transform CGT_{N/3}. CGT_{N/3} can also be similarly decomposed into a smaller sized convolution and CGT_{N/3}². Since all the resultant convolutions can be done concurrently, one can get a bilinear algorithm for the DCT-IV from the bilinear algorithms for cyclic convolutions.

The above discussion results in 2·3ⁿ-point DCT-IV algorithm with the bilinear complexity of (9·5ⁿ+36n+15)/8 multiplications and (18·5−29 3ⁿ+36n+11)72 additions. Thus the bilinear complexity of 4·3″ point MDCT is (9 5ⁿ+36n+15)/8 multiplications and (18·5ⁿ−25·3ⁿ+36n/2+11)/2 additions. The bilinear complexity of 4·3ⁿ point IMDCT is (9·5ⁿ+36n+15)/8 multiplications and (18·5ⁿ−293ⁿ+36n+11)/2 additions. Given the complexity requirements, our bilinear algorithm works best at smaller transform sizes where the hardware implementation is possible. This is the case for MPEG-1/2 layer III (MP3) audio processing, which is discussed below.

A 12-point MDCT/IMDCT is used for short block in MP3 audio processing. As discussed above, these transforms can be converted to a 6-point DCT-IV. Bilinear algorithms for DCT-IV can then be applied to obtain a fast VLSI implementation.

For DCT-IV signal indices i=1 and 4 where (2i+1) is divisible by 3, compute a 2-point DCT-IV. Let its outputs be X_{c}(0) and X_{c}(1), using the same shorthand notation as before, we have

$$( \begin{matrix}{X}_{c} ( 0 ) \\ {X}_{c} ( 1 )\end{matrix} ) = ( \begin{matrix}3 & 9 \\ 9 & \tilde{3}\end{matrix} ) ( \begin{matrix}x ( 1 ) \\ x ( 4 )\end{matrix} ) . \qquad ( 4.29 )$$

Add X_{c}(0) to the rest of X(0) and subtract it from the rest of X(3) and X(4). Similarly subtract X_{c}(1) from the rest of X(2) and add it to the rest of X(1) and X(5).

To compute DCT-IV transform indices k=1 and 4 where (2k+1) is divisible by 3, Using the same shorthand notation as before, we get

$$( \begin{matrix}{X}_{k} ( 1 ) \\ {X}_{k} ( 4 )\end{matrix} ) = ( \begin{matrix}3 & 9 \\ 9 & \tilde{3}\end{matrix} ) ( \begin{matrix}x ( 0 ) - x ( 3 ) \\ - ( x ( 5 ) + x ( 2 ) )\end{matrix} ) . \qquad ( 4.30 )$$

One can notice that the computation (4.30) is a Hankel product. As demonstrated below, the advantage of the signal division approach is that (4.30) can be completely obtained from the remaining matrix calculation with only sign changes.

For the remaining matrix, i.e., when (2i+1) ∈ A(8N) and (2k+1) ∈ A(8N), we have h=2N+1=13 to be the generator of C4 and g=7 to be the generator of C_{2·3}ⁿ⁻¹=C₂. One therefore gets {φ(0, 0), φ(1, 0), φ(0, 1), φ(1, 1)}={1, 11, 7, 5} and the corresponding ψ values are {1, −1, 1, 1}. In addition, since φ(a, b) equals (2i+1) or (2k+1), the signal or transform sample index needs to be permuted as {0, 5, 3, 2}. The resultant matrix equation is given by:

$$( \begin{matrix}{X}_{k} ( 0 ) \\ - {X}_{k} ( 5 ) \\ {X}_{k} ( 3 ) \\ {X}_{k} ( 2 )\end{matrix} ) = ( \begin{matrix}1 & \overline{11} & 7 & 5 \\ \overline{11} & \overline{1} & 5 & \overline{7} \\ 7 & 5 & 1 & \overline{11} \\ 5 & \overline{7} & \overline{11} & \overline{1}\end{matrix} ) ( \begin{matrix}x ( 0 ) \\ - x ( 5 ) \\ x ( 3 ) \\ x ( 2 )\end{matrix} ) \qquad ( 4.31 )$$

One can notice that this computation corresponds to a two dimensional convolution with 2-point convolution along one dimension and a 2-point Hankel product along the other. Clearly, efficient bilinear algorithm can be constructed for (4.31). Applying 2-point bilinear algorithm for cyclic convolution to (4.31), one computes {Xₖ(0), Xₖ(5)} with

$$( \begin{matrix}{X}_{k} ( 0 ) \\ - {X}_{k} ( 5 )\end{matrix} ) = \frac{1}{2} ( \begin{matrix}1 + 7 & \overline{11} + 5 \\ \overline{11} + 5 & \overline{1} + \overline{7}\end{matrix} ) ( \begin{matrix}x ( 0 ) + x ( 3 ) \\ - x ( 5 ) + x ( 2 )\end{matrix} ) . \qquad ( 4.32 )$$

This is a 2-point Hankel product and a bilinear algorithm can be applied with 3 multiplications and 3 additions.

Similarly, one can compute the other transform components {Xₖ(3), Xₖ(2)} with

$$( \begin{matrix}{X}_{k} ( 3 ) \\ {X}_{k} ( 2 )\end{matrix} ) = \frac{1}{2} ( \begin{matrix}1 - 7 & \overline{11} - 5 \\ \overline{11} - 5 & \overline{1} - \overline{7}\end{matrix} ) ( \begin{matrix}x ( 0 ) - x ( 3 ) \\ - ( x ( 5 ) + x ( 2 ) )\end{matrix} ) . \qquad ( 4.33 )$$

This is again a 2-point Hankel product and a bilinear algorithm can be applied with 3 multiplications and 3 additions.

It can be easily verified that for N=6,

cos(9π/4N)=cos(π/4N)−cos(7π/4N),

−cos(3π/4N)=−cos(11π/4N)−cos(5π/4N) (4.34)

Therefore one can express (4.33) as

$$( \begin{matrix}{X}_{k} ( 3 ) \\ {X}_{k} ( 2 )\end{matrix} ) = \frac{1}{2} ( \begin{matrix}9 & \overline{3} \\ \overline{3} & \overline{9}\end{matrix} ) ( \begin{matrix}x ( 0 ) - x ( 3 ) \\ - ( x ( 5 ) + x ( 2 ) )\end{matrix} ) . \qquad ( 4.35 )$$

Comparing (4.35) with (4.30), one gets

Xₖ(1)=−2Xₖ(2),

Xₖ(4)=2Xₖ3). (4.36)

Therefore computation for (4.30) can be absorbed into the that for (4.31). The operation of multiplying-by-2 may be counted as one addition. Frequently in hardware design, this scale-by-2 can be realized as a trivial left shift and thus its impact on area and speed is negligible.

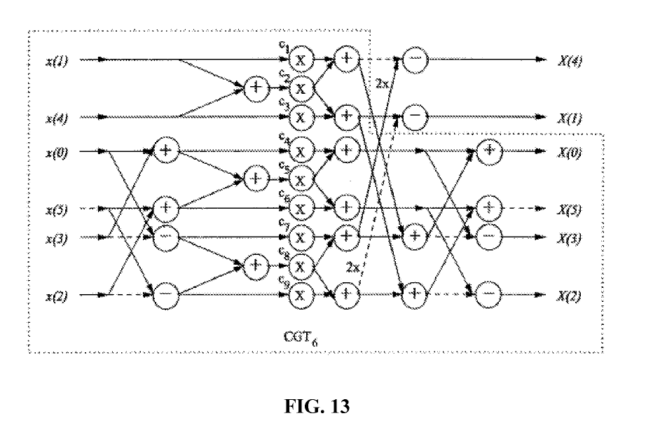

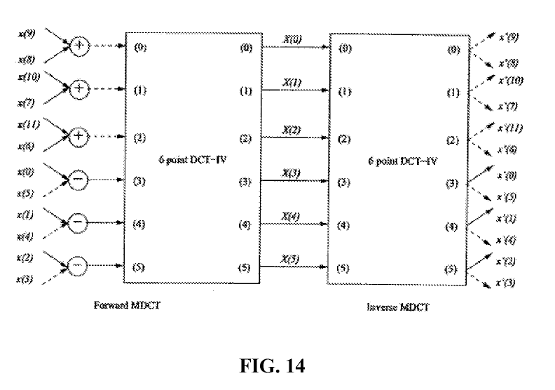

The complete flow graph of this computation is shown in FIG. 13. The multiplication coefficients are listed in Table 3. Architecture of 12-point MDCT/IMDCT based on this DCT-IV is given in FIG. 14.

TABLE 3
Multiplication coefficients used in FIG. 13.

| Coefficient | Value | Coefficient | Value | Coefficient | Value |
|---|---|---|---|---|---|
| c₁ | 0.5412 | c₂ | 0.3827 | c₃ | −1.3066 |
| c₄ | 0.4687 | c₅ | 0.3314 | c₆ | −1.1315 |
| c₇ | 0.6533 | c₈ | −0.4619 | c₉ | −0.2706 |

Our algorithms may be compared to those available in the literature [9, 27, 37]. The complexities and critical path delays of these are listed in Table 4. The bilinear algorithms improve both the arithmetic complexity and the critical path delay compared with the referenced fast algorithms.

TABLE 4
Complexities of various 12-point MDCT and IMDCT algorithms.

| Transform | Algorithm | Arithmetic complexity | Critical delay |
|---|---|---|---|
| 6-point DCT-IV | Proposed | 9M + 23A | M + 5A |
| 6-point CGT | Proposed | 9M + 19A | M + 5A |
| 12-point MDCT | Proposed | 9M + 29A | M + 6A |
| 12-point MDCT | Ref. [9] | 11M + 39A | 2M + 6A |
| 12-point MDCT | Ref. [37] | 13M + 27A | 2M + 5A |
| 12-point MDCT | Ref. [27] | 11M + 29A | 3M + 7A |
| 12-point IMDCT | Proposed | 9M + 23A | M + 5A |
| 12-point IMDCT | Ref. [9] | 11M + 33A | 2M + 5A |
| 12-point IMDCT | Ref. [37] | 13M + 21A | 2M + 4A |
| 12-point IMDCT | Ref. [27] | 11M + 23A | 3M + 6A |

Note that M and A refer to multiplication and addition, respectively.

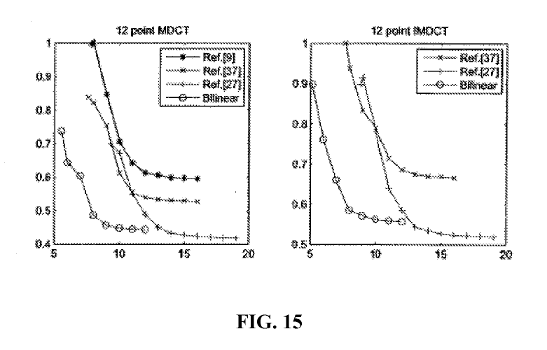

We have implemented these algorithms in 16-bit fixed arithmetic with TSMC 90 nm CMOS standard cell library. The circuit speed and normalized area for various 12-point MDCT/IMDCT architectures is compared in FIG. 15. The top speed of the forward bilinear implementation is 28% to 30% faster than those of Given's rotation based forward transforms [9, 37] and is 41% faster than the recursive approach in [27]. On the inverse transform, the top speed advantage is 34% faster over [37] and 42% faster over [27]. Given the same speed, the area for bilinear circuits can be as much as 41% and 18% smaller than those of [37] and [27] respectively for the forward, and 38% and 18% smaller respectively for the inverse. Clearly our bilinear algorithm provides the most efficient implementation of 12-point MDCT.

A further example embodiment herein includes the architecture for a 36-point MDCT/IMDCT via N=18 point DCT-IV. The DCT-IV components X(1), X(4), X(7), X(10), X(13) and X(16) can be computed by a 6-point DCT-IV. For the remaining components of CGT₁₈, we further divide the kernel matrix in two parts. A CGT₆ is computed for signal indices i=1, 4, 7, 10, 13, 16. The computation involving signal and transform indices i, k ∈{0, 2, 3, 5, 6, 8, 9, 11, 12, 14, 15, 17}, i.e., those for which (2i+1), (2k+1) ∈ A(8N), results into a multi-dimensional convolution. As explained earlier, this convolution is based upon the group C₄×C_{2·3}ⁿ⁻¹. Since the cyclic group C_{2·3}ⁿ⁻¹ can be further expressed as C₂×C_{2·3}ⁿ⁻¹, in (4.23) and (4.24), we can substitute in [symbol] where g₂ and g₃ are generators for C₂ and C₃ⁿ⁻¹ respectively. By using the generator h=19 of C4, generator g₂=17 of C₂ and generator g₃=49 of C₃, we get the values of function φ, a=0, 1, from (4.23) as {1, 19, 23, 5, 25, 29, 17, 35, 31, 13, 7, 11}. The corresponding values of function ψ are obtained from (4.24) as {1, 1, −1, −1, −1, 1, 1, 1, 1, 1, −1, −1}. Further, represents values of (2i+1) or (2k+1), where i and k are indices of signal and transform samples. Thus the permutation of the signal and transform samples can be derived from the values of φ. For the present set φ values, this index order is given by {0, 9, 11, 2, 12, 14, 8, 17, 15, 6, 3, 5}. The computation can thus be expressed as the matrix product:

$$( \begin{matrix}{X}_{k} ( 0 ) \\ {X}_{k} ( 9 ) \\ - {X}_{k} ( 11 ) \\ - {X}_{k} ( 2 ) \\ - {X}_{k} ( 12 ) \\ {X}_{k} ( 14 ) \\ {X}_{k} ( 8 ) \\ {X}_{k} ( 17 ) \\ {X}_{k} ( 15 ) \\ {X}_{k} ( 6 ) \\ - {X}_{k} ( 3 ) \\ - {X}_{k} ( 5 )\end{matrix} ) = ( \begin{matrix}1 & 19 & \overline{23} & \overline{5} & \overline{25} & 29 & 17 & 35 & 31 & 13 & \overline{7} & \overline{11} \\ 19 & \overline{1} & \overline{5} & 23 & 29 & 25 & 35 & \overline{17} & 13 & \overline{31} & \overline{11} & 7 \\ \overline{23} & \overline{5} & \overline{25} & 29 & 1 & 19 & 31 & 13 & \overline{7} & \overline{11} & 17 & 35 \\ \overline{5} & 23 & 29 & 25 & 19 & \overline{1} & 13 & \overline{31} & \overline{11} & 7 & 35 & \overline{17} \\ \overline{25} & 29 & 1 & 19 & \overline{23} & \overline{5} & \overline{7} & \overline{11} & 17 & 35 & 31 & 13 \\ 29 & 25 & 19 & \overline{1} & \overline{5} & 23 & \overline{11} & 7 & 35 & \overline{17} & 13 & \overline{31} \\ 17 & 35 & 31 & 13 & \overline{7} & \overline{11} & 1 & 19 & \overline{23} & \overline{5} & \overline{25} & 29 \\ 35 & \overline{17} & 13 & \overline{31} & \overline{11} & 7 & 19 & \overline{1} & \overline{5} & 23 & 29 & 25 \\ 31 & 13 & \overline{7} & \overline{11} & 17 & 35 & \overline{23} & \overline{5} & \overline{25} & 29 & 1 & 19 \\ 13 & \overline{31} & \overline{11} & 7 & 35 & \overline{17} & \overline{5} & 23 & 29 & 25 & 19 & \overline{1} \\ \overline{7} & \overline{11} & 17 & 35 & 31 & 13 & \overline{25} & 29 & 1 & 19 & \overline{23} & \overline{5} \\ \overline{11} & 7 & 35 & \overline{17} & 13 & \overline{31} & 29 & 25 & 19 & \overline{1} & \overline{5} & 23\end{matrix} ) ( \begin{matrix}x ( 0 ) \\ x ( 9 ) \\ - x ( 11 ) \\ - x ( 2 ) \\ - x ( 12 ) \\ x ( 14 ) \\ x ( 8 ) \\ x ( 17 ) \\ x ( 15 ) \\ x ( 6 ) \\ - x ( 3 ) \\ - x ( 5 )\end{matrix} ) \qquad ( 4.37 )$$

Note that we use p in this matrix to represent the value cos(πp/4N) and p̅ for the value cos(πp/4N), where N=18. The 6-point cyclic convolution can be obtained by combining 2-point and 3-point algorithms.

Efficient bilinear algorithms exist for the 2-point and 3-point cyclic convolution and Hankel product. For the 3-point cyclic convolution, applying the trigonometric identity cos(α) cos(2π/3+α)+cos(4π/3+α)=0, we can lower its complexity to 3 multiplications and 6 additions and reduce the critical path delay to 1 multiplication and 4 additions.

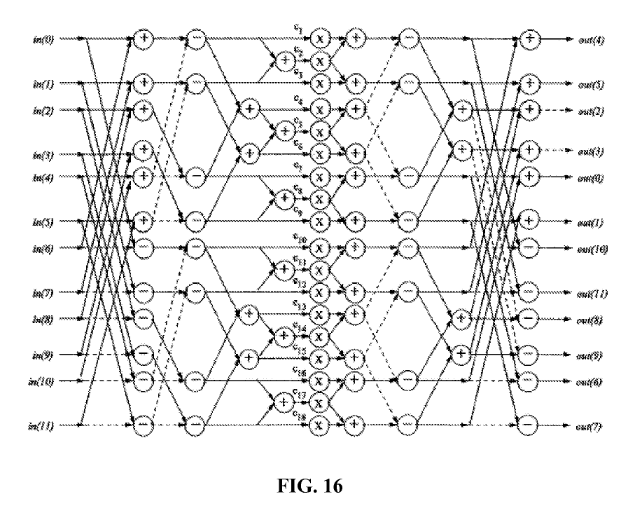

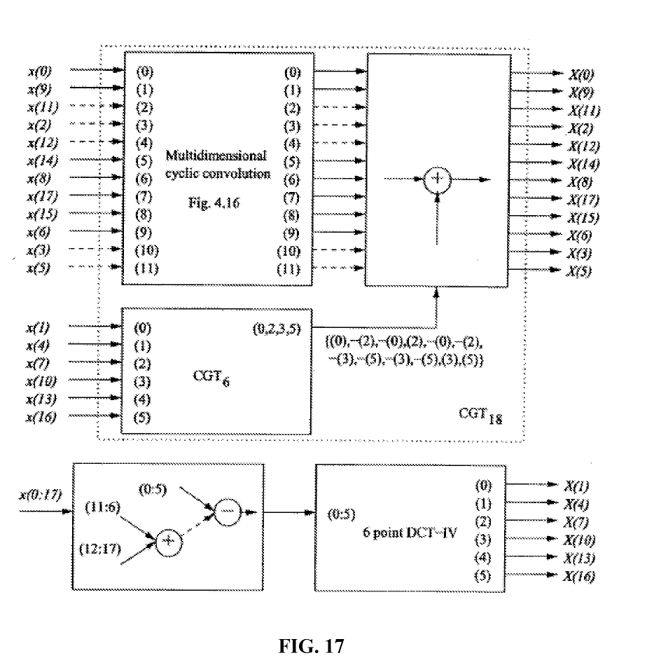

The flow graph for (4.37) is shown in FIG. 16. The complete implementation flow graph for 18-point DCT-IV is shown in FIG. 17. The multiplication coefficients used therein are listed in Table 5.

TABLE 5
Multiplication coefficients used in FIG. 16.

| Coefficient | Value | Coefficient | Value | Coefficient | Value |
|---|---|---|---|---|---|
| c₁ | −0.9231 | c₂ | −0.6528 | c₃ | 2.2287 |
| c₄ | −0.5086 | c₅ | −0.3596 | c₆ | 1.2278 |
| c₇ | −0.6025 | c₈ | −0.4261 | c₉ | 1.4546 |
| c₁₀ | −0.1628 | c₁₁ | 0.2779 | c₁₂ | −0.3930 |
| c₁₃ | 0.1851 | c₁₄ | −0.3160 | c₁₅ | 0.4469 |
| c₁₆ | 0.7181 | c₁₇ | −1.2258 | c₁₈ | 1.7336 |

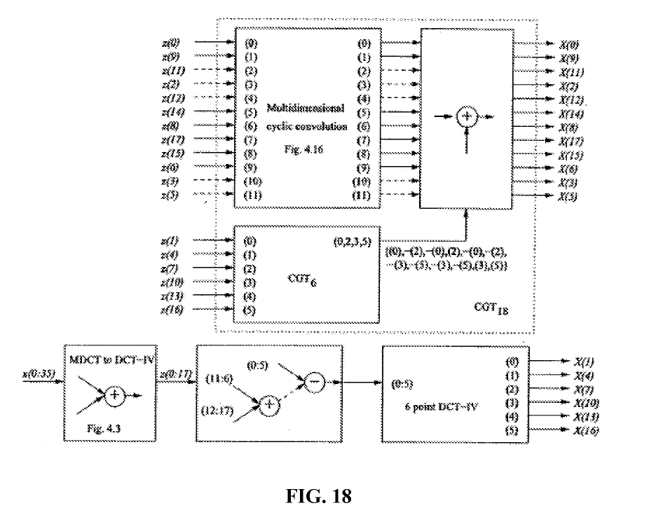

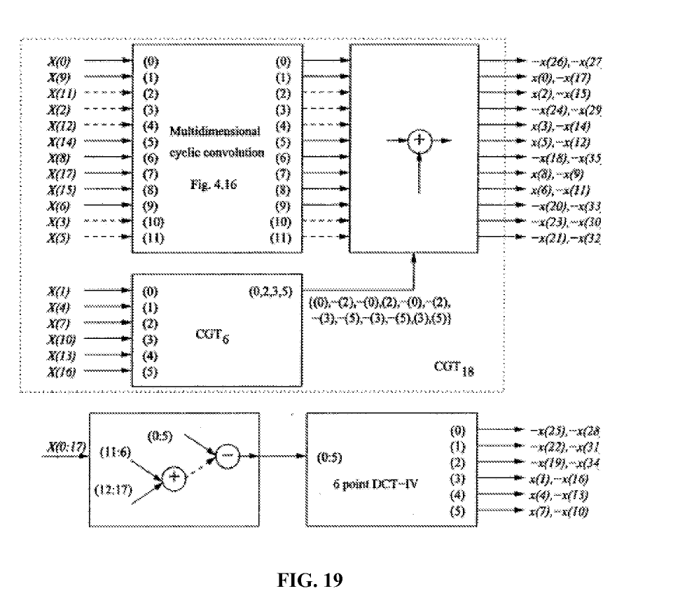

FIGS. 18 and 19 show the 36-point MDCT and IMDCT respectively. The complexities and critical path delays of these and of other algorithms available in literature are listed in Table 6.

TABLE 6
Complexities of various 36-point MDCT and IMDCT algorithms.

| Transform | Algorithm | Arithmetic complexity | Critical delay |
|---|---|---|---|
| 18-point DCT-IV | Proposed | 36M + 132A | M + 9A |
| 36-point MDCT | Proposed | 36M + 150A | M + 10A |
| 36-point MDCT | Ref. [9] | 47M + 165A | 2M + 9A |
| 36-point MDCT | Ref. [37] | 47M + 129A | 2M + 8A |
| 36-point MDCT | Ref. [27] | 43M + 133A | 3M + 22A |
| 36-point IMDCT | Proposed | 36M + 132A | M + 9A |
| 36-point IMDCT | Ref. [9] | 51M + 151A | 2M + 8A |
| 36-point IMDCT | Ref. [37] | 51M + 115A | 2M + 7A |
| 36-point IMDCT | Ref. [27] | 43M + 115A | 3M + 21A |

Note that M and A refer to multiplication and addition, respectively.

One can see from the table that the bilinear algorithm improves the critical path delay and has the lowest multiplication requirements. The addition operations however are higher than [27, 37].

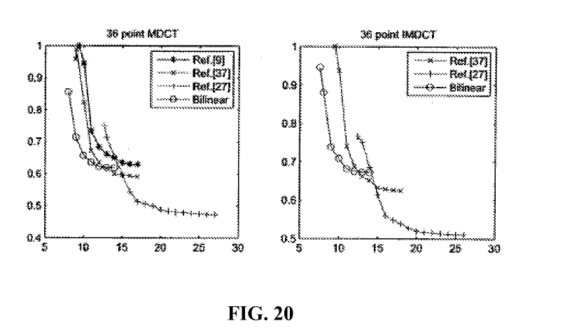

Such bilinear algorithms and the reference algorithms are implemented in 16-bit fixed arithmetic with TSMC 90 nm CMOS standard cell library. The circuit speed and normalized area is shown in FIG. 20. The top speed of the forward bilinear implementation is 10% to 14% faster than those of Given's rotation based forward transforms [9, 37] and is 36% faster than Lee's approach [27]. On the inverse transform, the top speed advantage is 20% over [37] and 39% over [27]. Given the same speed, the area for bilinear circuits can be as much as 27% smaller than that of [37] for the forward and 24% smaller for the inverse. Lee's circuit however can be smaller, but much slower.

In FIG. 5, we have shown that the forward and inverse MDCT can be obtained together on a DCT-IV based hardware architecture. This is accomplished with relatively simple input and/or output data multiplexers. This unified implementation allows encoder and decoder to share the same hardware accelerator through time multiplexing.

In MPEG-1/2 layer III (MP3) audio format, two different block sizes are defined. The long block size is normally used to provide better frequency resolution and the short block is used where as better time resolution is needed. The switch from the long block to the short block occurs whenever pre-echo is expected. Pre-echo is a distortion in the frequency domain coding of an audio signal. It is commonly dealt with using a window switching technique, where short block sizes are used in place of long block sizes. Therefore a truly unified algorithmic accelerator will need to process not only the forward and inverse (unified encoder and decoder), but also the short and long block sizes (window switching).

FIGS. 18 and 19 show that 36-point MDCT/IMDCT consists of three major processing modules: a 12-point block circular matrix, a 6-point CGT and a 6-point DCT-IV. Both 12-point MDCT and IMDCT rely on 6-point DCT-IV. These observations lead us to three different unified hardware architectures.

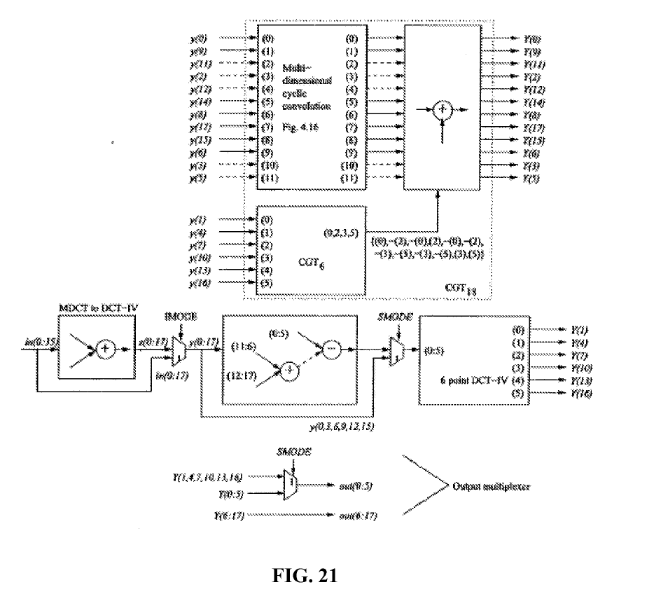

Shown in FIG. 21, example architecture A is a straightforward enhancement to the unified architecture FIG. 6. We use the 6-point DCT-IV inside the 36-point MDCT/IMDCT to process the 12-point MDCT/IMDCT. The data throughput is one 36-point or one 12-point MDCT/IMDCT per cycle. The pre-addition stages of 12-point MDCT is shared with that of the 36-point MDCT. Tables 7 and 8 show possible input and output assignments for FIG. 21.

TABLE 7
12 and 36 point MDCT and IMDCT input
mapping for unified architecture A.

| Input | MDCT₃₆ | IMDCT₃₆ | MDCT₁₂ | IMDCT₁₂ |
|---|---|---|---|---|
| SMODE | 0 | 0 | 1 | 1 |
| IMODE | 0 | 1 | 0 | 1 |
| in(0) | x(0) | X(0) | x(0) | X(0) |
| in(1) | x(1) | X(1) | | |
| in(2) | x(2) | X(2) | | |
| in(3) | x(3) | X(3) | x(1) | X(1) |
| in(4) | x(4) | X(4) | | |
| in(5) | x(5) | X(5) | | |
| in(6) | x(6) | X(6) | x(2) | X(2) |
| in(7) | x(7) | X(7) | | |
| in(8) | x(8) | X(8) | | |
| in(9) | x(9) | X(9) | | X(3) |
| in(10) | x(10) | X(10) | | |
| in(11) | x(11) | X(11) | x(3) | |
| in(12) | x(12) | X(12) | | X(4) |
| in(13) | x(13) | X(13) | | |
| in(14) | x(14) | X(14) | x(4) | |
| in(15) | x(15) | X(15) | | X(5) |
| in(16) | x(16) | X(16) | | |
| in(17) | x(17) | X(17) | x(5) | |
| in(18) | x(18) | | | |
| in(19) | x(19) | | | |
| in(20) | x(20) | | x(6) | |
| in(21) | x(21) | | | |
| in(22) | x(22) | | | |
| in(23) | x(23) | | x(7) | |
| in(24) | x(24) | | | |
| in(25) | x(25) | | | |
| in(26) | x(26) | | x(8) | |
| in(27) | x(27) | | x(9) | |
| in(28) | x(28) | | | |
| in(29) | x(29) | | | |
| in(30) | x(30) | | x(10) | |
| in(31) | x(31) | | | |
| in(32) | x(32) | | | |
| in(33) | x(33) | | x(11) | |
| in(34) | x(34) | | | |
| in(35) | x(35) | | | |

TABLE 8
12 and 36 point MDCT and IMDCT output
mapping for unified architecture A.

| Output | MDCT₃₆ | IMDCT₃₆ | | MDCT₁₂ | IMDCT₁₂ | |
|---|---|---|---|---|---|---|
| out(0) | X(0) | −x′(27), | −x′(26) | X(0) | −x′(9), | −x′(8) |
| out(1) | X(1) | −x′(28), | −x′(25) | X(1) | −x′(10), | −x′(7) |
| out(2) | X(2) | −x′(29), | −x′(24) | X(2) | −x′(11), | −x′(6) |
| out(3) | X(3) | −x′(30), | −x′(23) | X(3) | x′(0), | −x′(5) |
| out(4) | X(4) | −x′(31), | −x′(22) | X(4) | x′(1), | −x′(4) |
| out(5) | X(5) | −x′(32), | −x′(21) | X(5) | x′(2), | −x′(3) |
| out(6) | X(6) | −x′(33), | −x′(20) | | | |
| out(7) | X(7) | −x′(34), | −x′(19) | | | |
| out(8) | X(8) | −x′(35), | −x′(18) | | | |
| out(9) | X(9) | x′(0), | −x′(17) | | | |
| out(10) | X(10) | x′(1), | −x′(16) | | | |
| out(11) | X(11) | x′(2), | −x′(15) | | | |
| out(12) | X(12) | x′(3), | −x′(14) | | | |
| out(13) | X(13) | x′(4), | −x′(13) | | | |
| out(14) | X(14) | x′(5), | −x′(12) | | | |
| out(15) | X(15) | x′(6), | −x′(11) | | | |
| out(16) | X(16) | x′(7), | −x′(10) | | | |
| out(17) | X(17) | x′(8), | −x′(9) | | | |

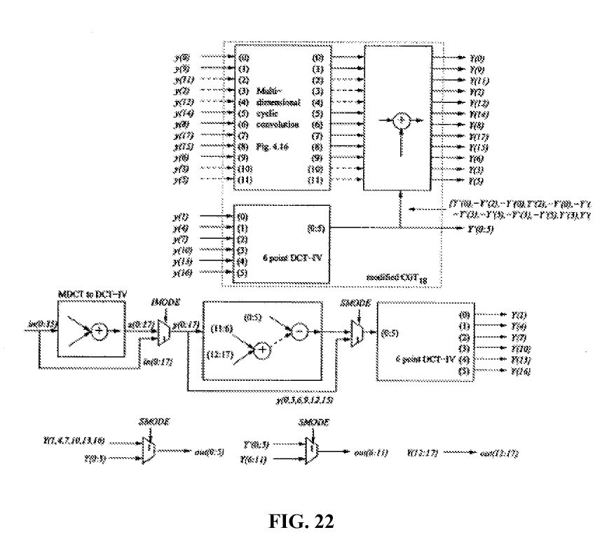

Example Architecture B shown in FIG. 22 improves upon the simple enhancement of FIG. 21. From Table 4, note that the difference between 6-point CGT and 6-point DCT-IV is small and only amounts to 4 additions (or 2 additions and 2 left shifts). Therefore 6-point CGT can be expanded into 6-point DCT-IV to process a second 12-point MDCT/IMDCT. The data throughput is one 36-point or two 12-point MDCT/IMDCT per cycle. The pre-addition stage for both 12-point MDCT's is shared with that of the 36-point MDCT. The ability to process multiple short blocks concurrently is important. During window switching, the 32 subbands can operate in mixed block mode, where two lower subbands process long blocks and all other 30 upper bands switch to short blocks. Tables 9 and 10 shows possible input and output assignments for FIG. 22.

TABLE 9
12 and 36 point MDCT and IMDCT input
mapping for unified architecture 13.

| Input | MDCT₃₆ | IMDCT₃₆ | MDCT₁₂ | IMDCT₁₂ |
|---|---|---|---|---|
| SMODE | 0 | 0 | 1 | 1 |
| IMODE | 0 | 1 | 0 | 1 |
| in(0) | x(0) | X(0) | x_{A}(0) | X_{A}(0) |
| in(1) | x(1) | X(1) | x_{B}(0) | X_{B}(0) |
| in(2) | x(2) | X(2) | | |
| in(3) | x(3) | X(3) | x_{A}(1) | X_{A}(1) |
| in(4) | x(4) | X(4) | x_{B}(1) | X_{B}(1) |
| in(5) | x(5) | X(5) | | |
| in(6) | x(6) | X(6) | x_{A}(2) | X_{A}(2) |
| in(7) | x(7) | X(7) | x_{B}(2) | X_{B}(2) |
| in(8) | x(8) | X(8) | | |
| in(9) | x(9) | X(9) | | X_{A}(3) |
| in(10) | x(10) | X(10) | x_{B}(3) | X_{B}(3) |
| in(11) | x(11) | X(11) | x_{A}(3) | |
| in(12) | x(12) | X(12) | | X_{A}(4) |
| in(13) | x(13) | X(13) | x_{B}(4) | X_{B}(4) |
| in(14) | x(14) | X(14) | x_{A}(4) | |
| in(15) | x(15) | X(15) | | X_{A}(5) |
| in(16) | x(16) | X(16) | x_{B}(5) | X_{B}(5) |
| in(17) | x(17) | X(17) | x_{A}(5) | |
| in(18) | x(18) | | | |
| in(19) | x(19) | | x_{B}(6) | |
| in(20) | x(20) | | x_{A}(6) | |
| in(21) | x(21) | | | |
| in(22) | x(22) | | x_{B}(7) | |
| in(23) | x(23) | | x_{A}(7) | |
| in(24) | x(24) | | | |
| in(25) | x(25) | | x_{B}(8) | |
| in(26) | x(26) | | x_{A}(8) | |
| in(27) | x(27) | | x_{A}(9) | |
| in(28) | x(28) | | x_{B}(9) | |
| in(29) | x(29) | | | |
| in(30) | x(30) | | x_{A}(10) | |
| in(31) | x(31) | | x_{B}(10) | |
| in(32) | x(32) | | | |
| in(33) | x(33) | | x_{A}(11) | |
| in(34) | x(34) | | x_{B}(11) | |
| in(35) | x(35) | | | |

Note that x_{A} and x_{B} refer to the two 6-point blocks whose MDCT is computed concurrently. Similarly X_{A} and X_{B} represent two independent 6-point transform blocks whose IMDCT is com^{p}uted concurrently.

TABLE 10
12 and 36 point MDCT and IMDCT output
mapping for unified architecture B.

| Output | MDCT₃₆ | IMDCT₃₆ | | MDCT₁₂ | IMDCT₁₂ | |
|---|---|---|---|---|---|---|
| out(0) | X(0) | −x′(27), | −x′(26) | X_{A}(0) | −x′_{A}(9), | −x′_{A}(8) |
| out(1) | X(1) | −x′(28), | −x′(25) | X_{A}(1) | −x′_{A}(10), | −x′_{A}(7) |
| out(2) | X(2) | −x′(29), | −x′(24) | X_{A}(2) | −x′_{A}(11), | −x′_{A}(6) |
| out(3) | X(3) | −x′(30), | −x′(23) | X_{A}(3) | x′_{A}(0), | −x′_{A}(5) |
| out(4) | X(4) | −x′(31), | −x′(22) | X_{A}(4) | x′_{A}(1), | −x′_{A}(4) |
| out(5) | X(5) | −x′(32), | −x′(21) | X_{A}(5) | x′_{A}(2), | −x′_{A}(3) |
| out(6) | X(6) | −x′(33), | −x′(20) | X_{B}(0) | −x′_{B}(9), | −x′_{B}(8) |
| out(7) | X(7) | −x′(34), | −x′(19) | X_{B}(1) | −x′_{B}(10), | −x′_{B}(7) |
| out(8) | X(8) | −x′(35), | −x′(18) | X_{B}(2) | −x′_{B}(11), | −x′_{B}(6) |
| out(9) | X(9) | x′(0), | −x′(17) | X_{B}(3) | x′_{B}(0), | −x′_{B}(5) |
| out(10) | X(10) | x′(1), | −x′(16) | X_{B}(4) | x′_{B}(1), | −x′_{B}(4) |
| out(11) | X(11) | x′(2), | −x′(15) | X_{B}(5) | x′_{B}(2), | −x′_{B}(3) |
| out(12) | X(12) | x′(3), | −x′(14) | | | |
| out(13) | X(13) | x′(4), | −x′(13) | | | |
| out(14) | X(14) | x′(5), | −x′(12) | | | |
| out(15) | X(15) | x′(6), | −x′(11) | | | |
| out(16) | X(16) | x′(7), | −x′(10) | | | |
| out(17) | X(17) | x′(8), | −x′(9) | | | |

Note that X_{A} and X_{B} refer to MDCTs of 6-point sequences x_{A} and x_{B} respectively and are computed concurrently. Similarly x′_{A} and x′_{B} refer to IMDCTs of 6-point transforms X_{A} and X_{B} respectively and are computed concurrently.

Example architecture C (pipeline) takes a different look at the relationship between the 6-point CGT and DCT-IV. Instead of doubling up CGT₆ to another DCT-IV in order to process a second short block, we fold CGT₆ function into the existing 6-point DCT-IV. This provides a natural way to pipeline the 36-point MDCT/IMDCT. In addition, a constant focal point of hardware implementation is the number of required input and output pins (JO).

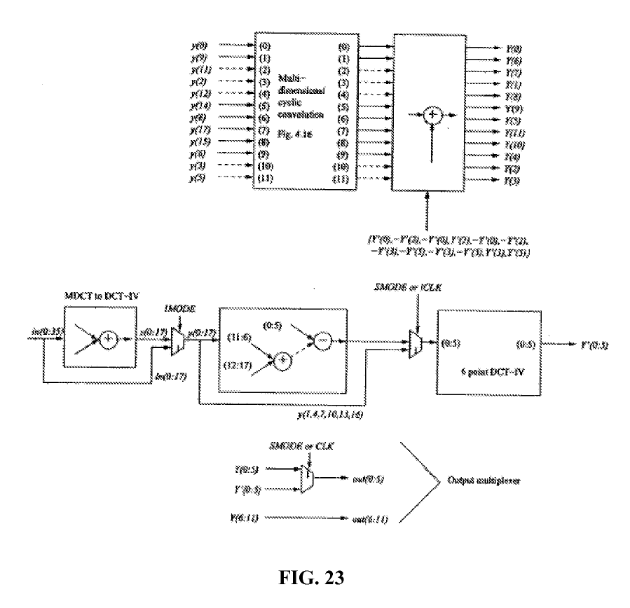

Many designs today are switching from die-limited to JO-limited. Therefore it is important to cap the number of input and output pins for a design. An example pipelined architecture is shown in FIG. 23. With the 6-point DCT-IV, 6 outputs of an 18-point DCT-IV are ready upon the completion of the first clock phase. During the second clock phase, we use the 6-point DCT-IV to compute CGT₆ and also complete the computation of multi-dimensional cyclic convolution. These 12 outputs of 18-point DCT-IV are then available at the end of second clock phase. Thus, we cut the required outputs from a maximum 36 for IMDCT to just 12 with the unified architecture, a 66% reduction.

The area savings comes from two sources. The major saving is from removing the CGT₆ computations of 9 multiplications and 21 additions. A secondary saving is due to the fact that block circular matrix is no longer on the critical path and thus can afford using smaller and low-power logic gates. The critical path for 36-point MDCT/IMDCT roughly doubles, compared to non-unified bilinear designs. However in one clock cycle, two short blocks can be processed and MP3 window switching can be accomplished rather fast. For the 36-point MDCT/IMDCT, the inputs only toggle on the rising edge of clock. 6 outputs are obtained on the falling edge and the other 12 outputs are obtained on the rising edge. For the 12-point, new inputs are sending on both rising and falling clock edges and outputs are generated on both rising and falling edges as well. Tables 11 and 12 show possible input and output assignments for the pipelined architecture of FIG. 23.

TABLE 11
12 and 36 point MDCT and IMDCT input mapping
for unified architecture C (pipeline).

| | Input | | | |
|---|---|---|---|---|
| | MDCT₃₆ | IMDCT₃₆ | MDCT₁₂ | IMDCT₁₂ |
| Clock edge | rise | rise | rise/fall | rise/fall |
| SMODE | 0 | 0 | 1 | 1 |
| IMODE | 0 | 1 | 0 | 1 |
| in(0) | X(0) | x(0) | | |
| in(1) | X(1) | x(1) | X(0) | x(0) |
| in(2) | X(2) | x(2) | | |
| in(3) | X(3) | x(3) | | |
| in(4) | X(4) | x(4) | X(1) | x(1) |
| in(5) | X(5) | x(5) | | |
| in(6) | X(6) | x(6) | | |
| in(7) | X(7) | x(7) | X(2) | x(2) |
| in(8) | X(8) | x(8) | | |
| in(9) | X(9) | x(9) | | |
| in(10) | X(10) | x(10) | X(3) | x(3) |
| in(11) | X(11) | x(11) | | |
| in(12) | X(12) | x(12) | | |
| in(13) | X(13) | x(13) | X(4) | x(4) |
| in(14) | X(14) | x(14) | | |
| in(15) | X(15) | x(15) | | |
| in(16) | X(16) | x(16) | X(5) | x(5) |
| in(17) | X(17) | x(17) | | |
| in(18) | X(18) | | | |
| in(19) | X(19) | | X(6) | |
| in(20) | X(20) | | | |
| in(21) | X(21) | | | |
| in(22) | X(22) | | X(7) | |
| in(23) | X(23) | | | |
| in(24) | X(24) | | | |
| in(25) | X(25) | | X(8) | |
| in(26) | X(26) | | | |
| in(27) | X(27) | | | |
| in(28) | X(28) | | X(9) | |
| in(29) | X(29) | | | |
| in(30) | X(30) | | | |
| in(31) | X(31) | | X(10) | |
| in(32) | X(32) | | | |
| in(33) | X(33) | | | |
| in(34) | X(34) | | X(11) | |
| in(35) | X(35) | 102 | | |

TABLE 12
12 and 36 point MDCT and IMDCT output mapping
for unified architecture C (pipeline)

| | MDCT₃₆ | | IMDCT₃₆ | | MDCT₁₂ | IMDCT₁₂ |
|---|---|---|---|---|---|---|
| Output | fall | rise | fall | rise | fall/rise | fall/rise |
| out(0) | X(1) | X(0) | −x′(28), −x′(25) | −x′(27), −x′(26) | X(0) | −x′(9), −x′(8) |
| out(1) | X(4) | X(2) | −x′(31), −x′(22) | −x′(29), −x′(24) | X(1) | −x′(10), −x′(7) |
| out(2) | X(7) | X(3) | −x′(34), −x′(19) | −x′(30), −x′(23) | X(2) | −x′(11), −x′(6) |
| out(3) | X(10) | X(5) | x′(1), −x′(16) | −x′(32), −x′(21) | X(3) | x′(0), −x′(5) |
| out(4) | X(13) | X(6) | x′(4), −x′(13) | −x′(33), −x′(20) | X(4) | x′(1), −x′(4) |
| out(5) | X(16) | X(8) | x′(7), −x′(10) | −x′(35), −x′(18) | X(5) | x′(2), −x′(3) |
| out(6) | | X(9) | | x′(0), −x′(17) | | |
| out(7) | | X(11) | | x′(2), −x′(15) | | |
| out(8) | | X(12) | | x′(3), −x′(14) | | |
| out(9) | | X(14) | | x′(5), −x′(12) | | |
| out(10) | | X(15) | | x′(6), −x′(11) | | |
| out(11) | | X(17) | | x′(8), −x′(9) | | |

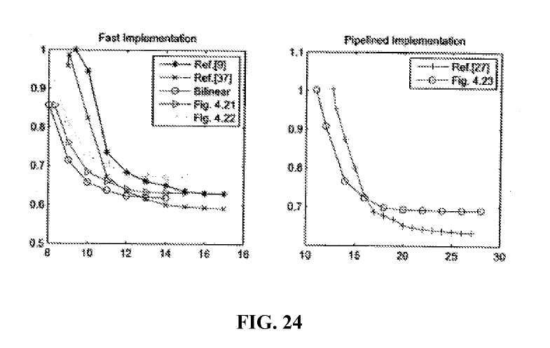

The complexity of the unified bilinear algorithms are listed in Table 13. The unified bilinear algorithms are implemented in 16-bit fixed arithmetic with TSMC 90 nm CMOS standard cell library. The circuit speed and normalized area is shown in FIG. 24. Architecture A is 3.6% slower at top speed than our bilinear MDCT, and is 5% larger when the speed is the same. Architecture B is 1.9% slower at top speed than our bilinear MDCT, and is 10% larger when the speed is the same.

We have also compared the fast unified architectures (A, B) with bilinear 36-point MDCT and [9, 37], and separately compared pipelined architecture efficient bilinear algorithms to compute MDCT/IMDCT of 2ⁿ and 4.3ⁿ points. The algorithms for composite lengths have practical applications in MP3 audio encoding and decoding. It is known that the MDCT/IMDCT can be converted to type-IV discrete cosine transforms (DCT-IV). Using group theory, our approach decomposes DCT-IV transform kernel matrix into groups of cyclic and Hanke product matrices. Bilinear algorithms are then applied to efficiently evaluate these groups. When implemented in VLSI, bilinear algorithms have improved the critical path delays over existing solutions. For MPEG-1/2 layer III (MP3) audio, we propose three different versions of unified hardware architectures for both the short and long blocks and the forward and inverse transforms.

TABLE 13
Complexities of unified 12 and 36 point MDCT
and IMDCT architectures for MP3 application.

| Architecture | Arithmetic complexity | Critical delay |
|---|---|---|
| A | 36M + 150A | M + 10A |
| B | 36M + 154A | M + 10A |
| C (pipeline) | 27M + 131A | 2M + 12A |

Note that M and A refer to multiplication and addition, respectively.

### REFERENCES

[1.] N. Anupindi, S. Narayanan, and K. prahbu. New radix-3 FHT algorithm. Electronics letters, 26(18):1537-1538, August 1990.
[2.] G. Bi. New split-radix algorithm for the discrete Hartley transform. IEEE Trans. Signal Processing, 45(2):297-302, February 1997.
[3.] R. E. Blahut. Fast algorithms for digital signal processing. Addison Esley, 1984.
[4.] S. Bouguezel, M. Ahmed, and M. Swamy. A new split-radix FHT algorithm for length-q *2m DHTs. IEEE Trans. Circuits Syst. I, 51(10):2031-2043, October 2004.
[5.] S. Boussakta and A. Holt. Prime factor Hartley and Hartley-like transform calculation using transversal filter-type structure. IEE Proceedings, 136(5):269-277, October 1989.
[6.] R. Bracewell. Discrete Hartley transform. J. Opt. Soc. Amer., 73:1832-1835, December 1983.
[7.] R. Bracewell. Aspects of the Hartley transform. Proc. IEEE, 82(3):381-387, March 1994.
[8.] V. Britanak and K. Rao. Correction to “an efficient implementation of the forward and inverse MDCT in MPEG audio coding”. IEEE Signal Processing Letters, 8(10):279, October 2001.
[9.] V. Britanak and K. Rao. An efficient implementation of the forward and inverse MDCT in MPEG audio coding. IEEE Signal Processing Letters, 8(2):48-50, February 2001.
[10.] V. Britanak and K. Rao. A new fast algorithm for the unified forward and inverse MDCT/MDST computation. Signal processing, 82(3):433-459, 2002.
[11.] C. Chakrabarti and J. Jaja. Systolic architectures for the computation of the discrete Hartley and the discrete cosine transforms based on prime factor decomposition. IEEE Trans. Computers, 39(11):1359-1990, November 1990.
[12.] D. Chan, J. Yang, and C. Fang. Fast implementation of MPEG audio coder using recursive formula with fast discrete cosine transforms. IEEE Trans. Speech, Audio Processing, 4(2):144-148, March 1996.
[13.] L. Chang and S. Lee. Systolic arrays for the discrete Hartley transform. IEEE Trans. Signal Processing, 39(11):2411-2418, November 1991.
[14.] C. Chen, B. Liu, and J. Yang. Recursive architectures for realizing modified discrete cosine transform and its inverse. IEEE Trans. Circuits Syst. II, 50(5):38-45, January 2003.
[15.] M. Cheng and Y. Hsu. Fast IMDCT and MDCT algorithms—a matrix approach. IEEE Trans Signal Processing, 51(1):221-229, January 2003.
[16.] Forward concepts. DSP market bulletin. http://www.fwdconcepts.com/dsp8104.htm, August 2004.
[17.] Q. Dai and X. Chen. New algorithm for modulated complex lapped transform with symmetrical window function. IEEE Signal Processing Letters, 11(12):925-928, December 2004.
[18.] P. Duhamel, Y. Mahieux, and J. Petit. A fast algorithm for the implementation of filter banks based on time domain aliasing cancellation. Proc. ICASSP, 3:2209-2212, April 1991.
[19.] A. Erickson and B. Fagin. Calculating the FHT in hardware. IEEE Trans. Signal Processing, 40(6):1341-1353, June 1992.
[20.] M. Balducci et. al Benchmarking of FFT algorithms. Proc. Eng. New Century, pages 328-330, March 1997.
[21.] A. Grigoryan. A novel algorithm for computing the 1D discrete Hartley transform. IEEE Signal Processing Letters, 11(2):156-159, February 2004.
[22.] S. Gudvangen and A. Holt. Computation of prime factor DFT and DHT/DCCT algorithms using cyclic skew-cyclic bit-serial semisytolic IC convolvers. IEE Proceedings, 137(5):373-389, October 1990.
[23.] J. Guo. An efficient design for one-dimensional discrete Hartley transform using parallel additions. IEEE Trans. Signal processing, 48(10):2806-2813, October 2000.
[24.] C. Jing and J. Tai. Fast algorithm for computing modulated lapped transform. Electronics Letters, 37(12):796-797, June 2001.
[25.] C. Kok. Fast algorithm for computing discrete cosine transform. IEEE Trans. Signal Processing, 45(3):757-760, March 1997.
[26.] C. Kwong and K. Shiu. Structured fast Hartley transform algorithms. IEEE Trans. Acoust., Speech, Signal Processing, ASSP-34(4):1000-1002, August 1986.
[27.] S. Lee. Improved algorithm for efficient computation of the forward and inverse MDCT in MPEG audio coding. IEEE Trans. Circuits Systs. II, 48(10):990-994, October 2001.
[28.] D. Lun and W. Siu. On prime factor mapping for the discrete Hartley transform. IEEE Trans. Signal Processing, 40(6):1399-1411, June 1992.
[29.] D. Lun and W. Siu. On prime factor mapping for the discrete Hartley transform. IEEE Trans. Signal Processing, 41(7):2494-2499, July 1993.
[30.]H. Malvar. Lapped transforms for efficient transform/subband coding. IEEE Trans. Acoust., Speech, Signal Processing, 38(6):969-978, June 1990.
[31.]H. Malvar. Signal processing with lapped transforms. Artech House, 1992.
[32.]H. Malvar. Biorthogonal and nonuniform lapped transofrs for transform coding with reduced blocking and ringing artifacts. IEEE Trans. Signal Processing, 46(4):1043-1053, April 1998.
[33.]H. Malvar. A modulated complex lapped transform and its applications to audio processing. Proc. ICASSP, pages 1421-1424, March 1999.
[34.]H. Malvar. Fast algorithm for the modulated complex lapped transform. IEEE Signal Processing Letters, 1(1):8-10, January 2003.
[35.] V. Muddhasani and M. D. Wagh. Bilinear algorithms for discrete cosine transforms of prime lengths. Signal Processing, 86:2393-2406, 2006.
[36.] V. Nikolajevic and G. Fettweis. Computation of forward and inverse MDCT using Clenshaw's recurrence formula. IEEE Trans. Signal Processing, 51(5):1439-1444, May 2003.
[37.] V. Nikolajevic and G. Fettweis. Improved implementation of MDCT in MP3 audio coding. 10th Asia-Pacific Conf. Comm. and 5th Intern. Symp. Multi-Dimen. Mobile Comm., 1:309-312, August 2004.
[38.] P. Noll. MPEG digital audio coding. IEEE Signal Processing Magazine, 14(5):59-81, September 1997.
[39.] D. Pann. A tutorial on MPEG audio compression. IEEE Multimedia, 2(2):60-74, Summer 1995.
[40.] K. Pahri. VLSI digital singal processing systems: design and implementation. John Wiley, 1999.
[41.] J. Princen and A. Bradley. Analysis/synthesis filter bank design based on time domain aliasing cancellation. IEEE Trans. Acoust. Speech Signal Processing, ASSP-34(5):1153-1161, October 1986.
[42.] C. Rader. Discrete Fourier transforms when the number of data samples is prime. Proc. IEEE, 56:104-105, June 1968.
[43.] K. Rao and P. Yip. Discrete consine transform: algorithms, advantages, applications. Academic Press, 1990.
[44.] M. Romdhane, V. Madisetti, and J. Hines. Quick-turnaround ASIC design in VHDL. Kluwer Academic Publisher, 1996.
[45.] D. Sevic and M. Popvic. A new efficient implementation of the oddly stacked Princen-Bradley filter bank. IEEE Signal Processing Letters, 1(11):166-168, November 1994.
[46.] S. Shlien. The modulated lapped transform, its time-varying forms, and its applications to audio coding standards. IEEE Trans. Speech and Audio processing, 5(4):359-366, July 1997.
[47.] International Consumer Electronics Show. Agenda for Enabling Technology Forms. http://www.enablingtechnologyforms.com/ces2005/index.htm, January 2005.
[48.] M. Smith. Application-specific integrated circuits. Addison Wesley, 1997.
[49.]H. Tai and C. Jing. Design and efficient implementation of a modulated complex lapped transform processor using pipelining technique. IEICE Trans. Fundamentals, E84-A(5):1280-1286, May 2001.
[50.] S. Tai, C. Wang, and C. Lin. FFT and IMDCT circuit sharing in DAB receiver. IEEE Trnas. Broadcasting, 49(2):124-131, June 2003.
[51.] T. Tsai, T. Chen, and L. Chen. An MPEG audio decoder chip. IEEE Trans. Consumer Electronics, 41(1):89-96, February 1995.
[52.] P. Vaidyanathan. Multirate systems and filter banks Prentice Hall, 1993.
[53.] M. Wagh. A new algorithm for the discrete cosine transform of arbitrary number of points. IEEE Trans. Computers, C-29(4):269-277, April 1980.
[54.] M. Wagh. Modular algorithms for cyclic convolution of arbitrary length. Lehigh University, February 2005.
[55.] M. Wagh. A structured bilinear algorithm for discrete Fourier transform. Lehigh University, February 2005.
[56.] Z. Wang. A fast algorithm for the discrete sine transform implemented by the fast cosine transform. IEEE Trans. Acoust, Speech, Signal Processing, ASSP-30(5): 814-815, October 1982.
[57.] Z. Wang. Fast algorithm for discrete W. Transform and for the discrete Fourier transform. IEEE Trans. Acoust., Speech, Signal Processing, ASP-32:803-816, Aug. 197-84.
[58.] Z. Wang. A prime factor fast W. transform and for the discrete Fourier transform. IEEE Trans. Signal Processing, 40(9)2361-2368, September 1992.
[59.] L. Wanhammar. DSP integrated circuits. Academic Press, 1999.
[60.] N. Weste and K. Eshraghian. Principles of CMOS VLSI design: a systems perspective. Addison Wesley, 2nd edition, 1992.
[61.] S. Winograd. On computing the discrete Fourier transform. Math Compt., 32:175-199, January 1978.
[62.] J. Wu and J. Shiu. Discrete Hartley transform in error control coding. IEEE Trans. Signal Processing, 39(10):2356-2359, October 1991.
[63.] Y. Yao, Q. Yao, P. Liu, and Z. Ciao. Embedded software optimization for MP3 decoder implemented on RISC core. IEEE Trans. Consumer Electronics, 50(4):1244-1249, June 2005.
[64.] P. Yeh. Data compression properties of the Hartley transform. IEEE Trans. Acoust., Speech, Signal Processing, 37(3):450-451, mar. 1989.
[65.] Z. Zhao. In-place radix-3 fast Hartley transform algorithm. Electronics Letters, 28(3):319-321, January 1992.

While this description is made with reference to exemplary embodiments, it will be understood by those skilled in the art that various changes may be made and equivalents may be substituted for elements thereof without departing from the scope. In addition, many modifications may be made to adapt a particular situation or material to the teachings hereof without departing from the essential scope. Also, in the Drawings and the description, there have been disclosed exemplary embodiments and, although specific terms may have been employed, they are unless otherwise stated used in a generic and descriptive sense only and not for purposes of limitation, the scope of the claims therefore not being so limited. Moreover, one skilled in the art will appreciate that certain steps of the methods discussed herein may be sequenced in alternative order or steps may be combined. Therefore, it is intended that the appended Claims not be limited to the particular embodiment disclosed herein.

1. A method for coding and decoding a digital signal in an MPEG format, the method comprising the steps of
providing at least one digital signal in an MPEG format;
applying an operation to the MPEG signal the operation comprising calculation of a forward modified discrete transform (MDCT) or the inverse modified discrete transform (IMDCT), wherein the applying of the operation results in at least one of 9 or less mutually independent multiplications for a 12-point MDCT or IMDCT, or 36 or less mutually independent multiplications for a 36-point MDCT or IMDCT.

2. The method of claim 1 wherein the operation provides for generation of at least one transform kernel, decomposition of the transform kernel into groups comprising any of cyclic, Hankel, and Toeplitz matrices, and application of at least one bilinear algorithm to each of the matrices, wherein the applying of the operation to each bilinear algorithm results in only one multiplication along the critical path in a hardware implementation

3. The method of claim 2, wherein the block size comprises: at least a short block size of 12 points, and at least a long block size of 36 points.

4. The method of claim 2, wherein the applying of each bilinear algorithm is performed concurrently for at least two short blocks.

5. The method of claim 3, wherein the MDCT or IMDCT comprise at least one 36-point MDCT or IMDCT, and wherein the operation comprises at least 2 processing modules, the modules including at least one 12-point matrix, and at least one of a 6-point CGT or a 6-point DCT-IV.

6. The method of claim 5, wherein the operation comprises using the 6-point DCT-IV inside the 36-point MDCT or IMDCT to process the 12-point MDCT or IMDCT in the same MPEG data stream so that the resulting data throughput is selected from the group consisting of at least one 36-point MDCT per cycle, at least one 36-point IMDCT per cycle, at least one 36-point MDCT and one 12-point MDCT per cycle, and at least one 36-point IMDCT and one 12-point IMDCT per cycle.

7. The method of claim 5, wherein the operation further comprises expanding 6-point CGT into 6-point DCT-IV to process a second 12-point MDCT or IMDCT, so that the resulting data throughput is selected from the group consisting of at least one 36-point MDCT per cycle, at least one 36-point IMDCT per cycle, and at least two 12-point MDCT per cycle, and at least two 12-point IMDCT per cycle.

8. The method of claim 5, wherein the operation comprises using the same 6-point CGT module for both the 12-point and 36-point MDCT or IMDCT so that the resulting throughput is selected from the group consisting of at least one 12-point MDCT per cycle, at least one IMDCT per cycle, at least one 36-point MDCT per every 2 cycles, and at least one 36-point IMDCT per every 2 cycles.

9. The method of claim 5, wherein the operation comprises using the 6-point DCT-IV to calculate the 6-point CGT.

10. The method of claim 1, wherein the step of applying the operation to the MPEG signal is performed by a unified accelerator, regardless of whether encoding or decoding the MPEG signal, and regardless of the block size defined for the MPEG signal format.

11. A hardware structure for coding and decoding a digital signal in an MPEG format, the structure comprising a microprocessor, and:
computer-readable instructions executable by the microprocessor for applying an operation to a MPEG signal,
the operation comprising calculation of a forward modified discrete transform (MDCT) or the inverse modified discrete transform (IMDCT), wherein the applying of the operation results in at least one of 9 or less mutually independent multiplications for a 12-point MDCT or IMDCT, or 36 or less mutually independent multiplications for a 36-point MDCT or IMDCT.

12. The hardware structure of claim 11, wherein the operation provides for generation of at least one transform kernel, decomposition of the transform kernel into groups comprising any of cyclic, Hankel, and Toeplitz matrices, and application of at least one bilinear algorithm to each of the matrices, wherein the applying of the operation to each bilinear algorithm results in only one multiplication along the critical path in a hardware implementation.

13. The method of claim 12, wherein the block size comprises: at least a short block size of 12 points, and at least a long block size of 36 points.

14. The method of claim 12, wherein the applying of each bilinear algorithm is performed concurrently for at least two short blocks.

15. The method of claim 13, wherein the MDCT or IMDCT comprise at least one 36-point MDCT or IMDCT, and wherein the operation comprises at least 2 processing modules, the modules including at least one 12-point matrix, and at least one of a 6-point CGT or a 6-point DCT-IV.

16. The method of claim 15, wherein the operation comprises using the 6-point DCT-IV inside the 36-point MDCT or IMDCT to process the 12-point MDCT or IMDCT in the same MPEG data stream so that the resulting data throughput is selected from the group consisting of at least one 36-point MDCT per cycle, at least one 36-point IMDCT per cycle, at least one 36-point MDCT and one 12-point MDCT per cycle, and at least one 36-point IMDCT and one 12-point IMDCT per cycle.

17. The method of claim 15 wherein the operation further comprises expanding 6-point CGT into 6-point DCT-IV to process a second 12-point MDCT or IMDCT, so that the resulting data throughput is selected from the group consisting of at least one 36-point MDCT per cycle, at least one 36-point IMDCT per cycle, and at least two 12-point MDCT per cycle, and at least two 12-point IMDCT per cycle.

18. The method of claim 16 wherein the operation comprises using the same 6-point CGT module for both the 12-point and 36-point MDCT or IMDCT so that the resulting throughput is selected from the group consisting of at least one 12-point MDCT per cycle, at least one IMDCT per cycle, at least one 36-point MDCT per every 2 cycles, and at least one 36-point IMDCT per every 2 cycles.

19. The method of claim 15 wherein the operation comprises using the 6-point DCT-IV to calculate the 6-point CGT.

20. The method of claim 11, wherein the step of applying the operation to the MPEG signal is performed by a unified accelerator, regardless of whether encoding or decoding the MPEG signal, and regardless of the block size defined for the MPEG signal format.

21. The hardware structure of claim 20, wherein the instructions provide for use of an associated dynamic window switching module and associated buffer memory to provide an efficient memory layout and a data arrangement method to store a plurality of data generated by the MDCT or IMDCT of the operation for providing a reading of a synthesis filter bank module.

22. The hardware structure of claim 21, wherein the operation, dynamic switching window module and the synthesis filter bank module can be implemented in a pipeline process manner.

23. The hardware structure of claim 22, wherein the writing of the MCDT or IMDCT transform of the sample data contained in each of the memory banks of the dynamic window buffer memory and the reading of the synthesis filter bank follow a specific sequence.

24. The hardware structure of claim 23, wherein the hardware structure is a hardware structure design of the post-process portion in the audio decoding process of the Layer3 compression method of the MPEG compression standard (MP3).
